(19) United States
(12) Patent Application Publication
(10) Pub. No.: US 2024/0028823 A1
(43) Pub. Date: Jan. 25, 2024

(54) SYSTEM AND METHOD FOR MAINTAINING LINKS AND REVISIONS

(71) Applicant: WORKIVA INC., Ames, IA (US)

(72) Inventors: Matthew Peter Hinrichsen, Ames, IA (US); Thomas Deering, Colorado Springs, CO (US); Eric Klaus, Ames, IA (US); Kyle James McMorrow, Ames, IA (US); Tanner Davis Miller, Alpharetta, GA (US); Nathaniel Wernimont, Huxley, IA (US)

(21) Appl. No.: 18/227,080

(22) Filed: Jul. 27, 2023

Related U.S. Application Data
(63) Continuation-in-part of application No. 18/089,785, filed on Dec. 28, 2022.
Application No. 18/089,785 is a continuation of application No. 17/407,737, filed on Aug. 20, 2021, now Pat. No. 11,544,451.
Application No. 17/407,737 is a continuation of application No. 16/994,944, filed on Aug. 17, 2020, now Pat. No. 11,100,281.

(51) Int. Cl. G06F 40/18; G06F 16/23; G06F 16/93; G06F 40/166; G06F 40/197

(52) U.S. Cl. CPC G06F 40/18; G06F 16/2343; G06F 16/93; G06F 40/166; G06F 40/197

(57) ABSTRACT

A method for maintaining revisions for a plurality of documents is described. Pending requests are stored in a workspace revision queue that is shared by the plurality of documents. The pending requests indicate revisions to be carried out on the plurality of documents. A pending request graph is generated for at least some pending requests from the workspace revision queue using a dependency graph for the plurality of documents. The dependency graph represents interdependencies of content references among the plurality of documents. The revisions indicated by the pending requests of the pending request graph are caused to be performed on the plurality of documents according to a dependency ordering based on the pending request graph. The dependency ordering is different from an ordering for the workspace revision queue.

### CROSS-REFERENCE TO RELATED APPLICATIONS

This application is a continuation-in-part of U.S. patent application Ser. No. 18/089,785, filed Dec. 28, 2022, which is a continuation of U.S. patent application Ser. No. 17/407,737, filed Aug. 20, 2021, now U.S. Pat. No. 11,544,451, which is a continuation of U.S. patent application Ser. No. 16/994,944, filed Aug. 17, 2020, now U.S. Pat. No. 11,100,281. This application is related to U.S. patent application Ser. No. 16/292,701, filed Mar. 5, 2019, now U.S. Pat. No. 10,733,369, which is a continuation of U.S. patent application Ser. No. 16/008,295, filed Jun. 14, 2018, now U.S. Pat. No. 10,275,441, which is a divisional of U.S. patent application Ser. No. 15/922,424, filed Mar. 15, 2018, now U.S. Pat. No. 10,255,263, which is a continuation-in-part of U.S. patent application Ser. No. 15/188,200, filed Jun. 21, 2016, now U.S. Pat. No. 10,019,433, which is a continuation of U.S. patent application Ser. No. 14/850,156, filed Sep. 10, 2015, now U.S. Pat. No. 9,378,269, which is a continuation of U.S. patent application Ser. No. 14/714,845, filed May 18, 2015, now U.S. Pat. No. 9,158,832. This application is also related to U.S. patent application Ser. No. 16/871,512, filed on May 11, 2020. Each of the above documents is incorporated herein by reference in its entirety.

### TECHNICAL FIELD

The present disclosure relates generally to electronic document management and, more particularly, to a data storage and retrieval system and method for maintaining links and revisions in a plurality of documents.

### BACKGROUND

Keeping track of different types of data entries and interdependencies among the different entries is a task for which computers are ideally suited, and modern society depends heavily on this capability. From social networking platforms to financial analysis applications, computers, along with robust communication networks, are able to propagate a change in one data item (e.g., a change in a cell of a spreadsheet or a change in a user's status on a social network) to other data items (e.g., a recalculation of a formula in a spreadsheet or an update of an emoticon on the devices of the user's friends).

One problem that arises with propagating changes among many interdependent data entries is that it can be very slow when the number of entries and interdependencies is high and when the entries are stored across different documents, databases, servers and different geographical locations of the servers. For example, those who work with large spreadsheets are familiar with the experience in which, when a change is made to one cell of a spreadsheet, the spreadsheet program spends a long time updating itself repeatedly as the formulas depending on the changed cell get recalculated, the formulas depending on those formulas get recalculated, and so on. Dependencies that cross documents or servers create similar delays.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an example of a networking environment in which various embodiments of the disclosure may be implemented, according to an embodiment;

FIG. 2 is a block diagram of a computing device, according to an embodiment.

FIG. 3 is a block diagram of an example database configured to store workspaces with separate revision counters using the computing device of FIG. 2, according to an embodiment;

FIGS. 4A to 4E and FIGS. 5A to 5E are diagrams showing a sequence of timeslices of revisions to spreadsheets with cells having formula dependencies and linking dependencies using document revision counters, according to an embodiment;

FIG. 6 is a flow diagram showing a sequence of revisions to documents using a workspace revision counter and document revision counters, according to an embodiment;

FIG. 7 is a flow diagram showing a sequence of revisions to documents having separate branches using a workspace revision counter and document revision counters, according to an embodiment;

FIG. 8 is a flow diagram showing a sequence of revisions to documents and integration of those revisions into other branches, according to an embodiment;

FIG. 9 is a flow diagram showing a sequence of revisions to documents using a workspace revision counter and a workspace revision queue where temporary revisions are displayed;

FIG. 10 is a flowchart illustrating an example method, implemented on a server, for rendering linked content in a first document having a table with a plurality of cells, according to an embodiment;

FIG. 11 is a diagram of an example spreadsheet and dependency graphs, according to an embodiment;

FIG. 12 is a diagram showing an example sequence of pending requests using a workspace revision queue, an example parallel processing graph for the workspace revision queue, and an example pending request graph based on a dependency graph;

FIGS. 13A-13C, 14A-14C, 15A-15C, 16A-16C, 17A-17C, and 18A-18C are diagrams showing examples of the workspace revision queue and pending request graph for processing of the pending requests of FIG. 12;

FIG. 19 is a flowchart illustrating an example method, implemented on a server, for maintaining revisions for a plurality of documents, according to an embodiment.

### DETAILED DESCRIPTION

In systems configured to maintain multiple documents with various dependencies on each other, and particularly those with dozens of documents of different types, the accuracy of a report or displayed output that purports to capture a “snapshot” or “time slice” of the content of the documents may depend upon whether a change in one document has propagated to another document. In some scenarios, a user viewing several documents at the same time, but where those documents are only a subset of the entire set of documents, may not be able to view an accurate snapshot until the changes have been propagated across the entire set. As one example, when a cell in a spreadsheet is used as a “source” for content displayed in a “destination” 10-K financial document and also used in a destination Exhibit document, a change made to the source spreadsheet may be propagated to the 10-K document first (i.e., before the change has propagated to the Exhibit), so at a certain time slice, the 10-K document has been updated, but the Exhibit document has not yet been updated, and a user viewing both the 10-K document and the Exhibit document at the same time may become confused when entries between the destination documents, with purportedly the same values, do not match each other.

Disclosed herein is a system for maintaining links and revisions for a plurality of documents. Various embodiments of the disclosure are implemented in a computer networking environment. The system is configured to receive requests that indicate revisions to be carried out on the plurality of documents where at least one of the requests corresponds to revisions for different documents of the plurality of documents. The plurality of documents may be referred to herein as a “workspace,” for example, a shared repository of a group of documents for a corporation or business unit. For each of the received requests, a workspace revision counter that is shared by the plurality of documents is incremented. The workspace revision counter indicates a revision state of the plurality of documents. In other words, the workspace revision counter indicates a revision state of the documents as an integral data unit, as opposed to separate data units for each document with respective document revision counters. A revision indicated by a request is caused to be performed on one or more documents that correspond to the request. In some scenarios, a single request indicates changes to multiple documents, for example, a request to update a link between a source element and a destination element.

In some examples, the system stores pending requests in the workspace revision queue, where the pending requests indicating revisions to be carried out on documents within the workspace. The system generates a pending request graph for at least some pending requests from the workspace revision queue using a dependency graph for the plurality of documents. The dependency graph represents interdependencies of content references among the plurality of documents (e.g., interdependencies among source documents and destination documents). The revisions indicated by the pending requests of the pending request graph are caused to be performed on the plurality of documents according to a dependency ordering based on the pending request graph. The dependency ordering may be different from an ordering for the workspace revision queue, for example, the revisions may be performed out of order, in parallel, etc. Generally, the system performs the revisions in parallel, distributed across multiple threads, processors, and/or computing devices, for improved processing speed while maintaining consistency for display of the documents.

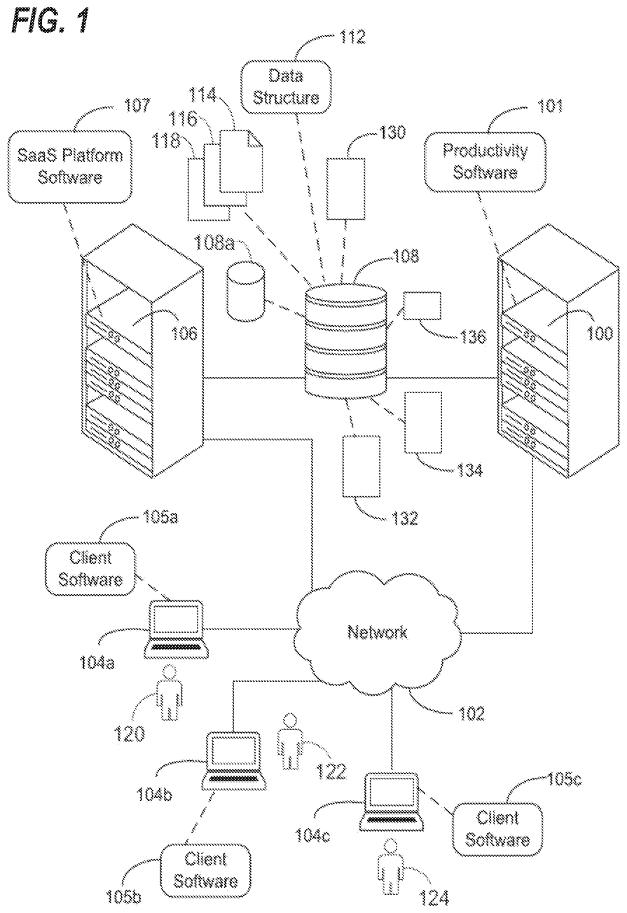

Turning to FIG. 1, an example of a computer networking environment in which various embodiments of the disclosure may be implemented is shown. A first computing device 100 is communicatively linked to a network 102. Possible implementations of the network 102 include a local-area network, a wide-area network, a private network, a public network (e.g., the Internet), or any combination of these. The network 102 may include both wired and wireless components. Also communicatively linked to the network 102 are a second computing device 104a, a third computing device 104b, a fourth computing device 104c, and a fifth computing device 106. The fifth computing device 106 is communicatively linked to a media storage device 108 (e.g., a redundant array of independent disks). For the sake of example, it is assumed that a first user 120 operates the second computing device 104a, a second user 122 operates the third computing device 104b, and a third user 124 operates the fourth computing device 104c. Each of the computing devices 104a, 104b, and 104c executes client software (reference numerals 105a, 105b, and 105c, respectively). One possible implementation of the client software is a web browser.

Residing within the media storage device 108 is a database 108a containing multiple documents, three of which are depicted in FIG. 1: a first document 114, a second document 116, and a third document 118. The first computing device 100 and the fifth computing device 106 are depicted as rack-mounted servers, while the second, third, and fourth computing devices 104a, 104b, and 104c are depicted as a notebook computers. However, the computing devices depicted in FIG. 1 are merely representative. Other possible implementations of a computing device include a desktop computer, a tablet computing, and a smartphone. Furthermore, although the first, second, and third documents 114, 116, and 118 are depicted as being stored in a single device, they may, in fact, be stored on multiple storage devices (e.g., sharded into multiple physical chunks) of a cloud storage service. Finally, there may be more than or fewer than the first, second, and third documents 114, 116, and 118 residing on the media storage device 108.

In various embodiments, at least some documents are stored using a suitable data structure configured to maintain links and references between cells, tables, paragraphs, sections, or other suitable portions of a document. In an embodiment, documents are stored using an RTree data structure. In another embodiment, documents are stored using a causal tree data structure.

In an embodiment, the system includes a computing device that configures the computer memory according to a causal tree (a type of logic tree) representing a structure of a document. The computer memory may be internal to or external to the computing device. Causal tree structures are useful representations of how content and metadata associated with the content are organized. For example, a document may be represented by a single causal tree structure or a bounded set of causal tree structures. The causal tree structure is useful in efficiently tracking and storing changes made in the document. A typical causal tree structure includes nodes of the editing instructions in the document, and each editing instruction has a unique identifier or ID. The editing instructions include, for example, text characters, insertion of text characters, deletion of text characters, formatting instructions, copy and paste, cut and paste, etc. In other words, a causal tree structure is a representation of all the instructions (regardless of type) that compose a document. The causal tree structure starts with a root node and a collection of observation instances, from which all other instruction nodes branch. Except for the root node and observations, each editing instruction in the document is caused by whichever editing instruction that came before it. Every editing instruction is aware of the ID of its parent instruction, i.e., the instruction that “caused” it. In an embodiment, each instruction (other than the root node and observations) in the document may be represented as a 3-tuple: ID (ID of the instruction), CauseID (ID of the parent instruction), and Value (value of the instruction). Observations have a 3-tuple: ID (ID of the instruction), Start ID (ID of the first character in a range), and Stop ID (ID of character immediately after the last character in a range unless the same as the Start ID which indicates only a single character is to be observed). Additional instructions may be added to an observation to provide additional information or to modify the range being observed. Examples of observations are discussed in U.S. patent application Ser. No. 16/871,512.

In an embodiment, the system includes a computing device that configures the computer memory according to an RTree (a type of logic tree) representing a structure of a spreadsheet or other document. The computer memory may be internal to or external to the computing device. In an embodiment, the RTree has a plurality of nodes, at least some of which contain one or more minimum bounding rectangles. Each minimum bounding rectangle (“MBR”) encompasses cells of the spreadsheet from a different one of a plurality of columns of the spreadsheet, but does not encompass cells of any of the other columns of the plurality of columns. A node of the RTree may hold multiple MBRs or a single MBR.

For convenient reference, the first computing device 100 will also be referred to as a “productivity server 100” and the fifth computing device 106 will be also be referred to as a “database server 106.” Although depicted in FIG. 1 as separate devices, in some embodiments, the functionality of the productivity server 100 and the database server 106 are on the same device. The productivity server 100 executes productivity software 101 to provide document collaboration services. The database server 106 executes Software-as-a-Service (“SaaS”) platform software 107 to provide database services to the productivity software 101, such as maintaining the contents of the database 108a and providing a programming platform for various processes launched by the productivity software (e.g., to manipulate, store, and retrieve documents and other information from the database 108a). Under the control of the productivity software 101, the productivity server 100 interacts with the database server 106 (which operates under the control of the SaaS platform software 107) and the computing devices 104a, 104b, and 104c (also referred to as “client devices”) to allow the computing devices to access the first document 114, the second document 116, and the third document 118 so that the first user 120, the second user 122, and the third user 124 can collaborate in editing the documents (e.g., moving sections around in a particular document).

In an embodiment, documents maintained on the media storage device 108 may be organized into sections, with each section (e.g., the contents of the section) being maintained in its own separate data structure referred to as a “section entity.” For example, the first document 114 in FIG. 1 has a first section represented by a first section entity 130, a second section represented by a second section entity 132, and a third section represented by a third section entity 134. The productivity software 101 uses an outline entity 136 (also stored on the media storage device) to determine how the sections are organized.

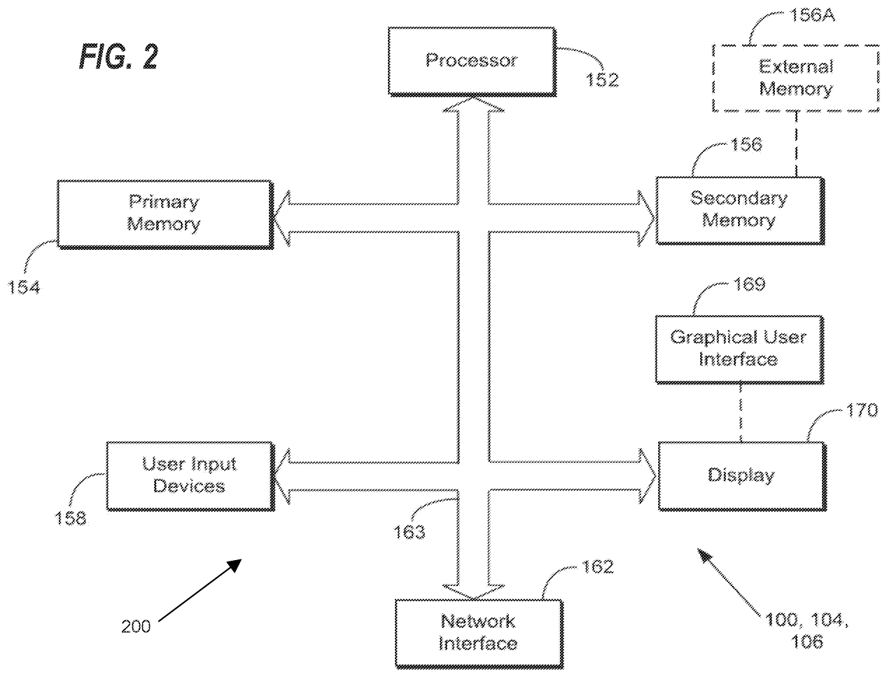

FIG. 2 is a block diagram of a computing device 200, according to an embodiment. One or more of the computing devices of FIG. 1 (including the media storage device 108) have the general architecture shown in FIG. 2, in various embodiments. The device depicted in FIG. 2 includes a processor 152 (e.g., a microprocessor, controller, or application-specific integrated circuit), a primary memory 154 (e.g., volatile memory, random-access memory), a secondary memory 156 (e.g., non-volatile memory, solid state drive, hard disk drive), user input devices 158 (e.g., a keyboard, mouse, or touchscreen), a display 160 (e.g., an organic, light-emitting diode display), and a network interface 162 (which may be wired or wireless). The memories 154 and 156 store instructions and data. The processor 152 executes the instructions and uses the data to carry out various procedures including, in some embodiments, the methods described herein.

Each of the elements of FIG. 2 is communicatively linked to one or more other elements via one or more data pathways 163. Possible implementations of the data pathways 163 include wires, conductive pathways on a microchip, and wireless connections. In an embodiment, the processor 152 is one of multiple processors in the computing device, each of which is capable of executing one or more separate threads. In an embodiment, the processor 152 communicates with other processors external to the computing device in order to initiate the execution of different threads on those other processors.

The term “local memory” as used herein refers to one or both of the memories 154 and 156 (i.e., memory accessible by the processor 152 within the computing device). In some embodiments, the secondary memory 156 is implemented as, or supplemented by an external memory 156A. The media storage device 108 is a possible implementation of the external memory 156A. The processor 152 executes the instructions and uses the data to carry out various procedures including, in some embodiments, the methods described herein, including displaying a graphical user interface 169. The graphical user interface 169 is, according to one embodiment, software that the processor 152 executes to display a report on the display device 160, and which permits a user to make inputs into the report via the user input devices 168.

The computing devices of FIG. 1 (i.e., the processor 152 of each of the computing devices) are able to communicate with other devices of FIG. 1 via the network interface 162 over the network 102. In an embodiment, this communication takes place via a user interface that the productivity server 150 provides to the computing devices 154a, 154b, and 154c. The specific nature of the user interface and what the user interface shows at any given time may vary depending on what the user has chosen to view. Also, multiple users may interact with different instances of the user interface on different devices. In some embodiments, the productivity server 150 carries out calculations to determine how content is to be rendered on a computing device, generates rendering instructions based on those calculations, and transmits those rendering instructions to the computing device. Using the received instructions, the computing device renders the content on a display. In other embodiments, the productivity server 150 transmits instructions regarding an asset to a computing device. In carrying out the received instructions, the computing device performs the appropriate calculations locally to render the content of the asset on a display.

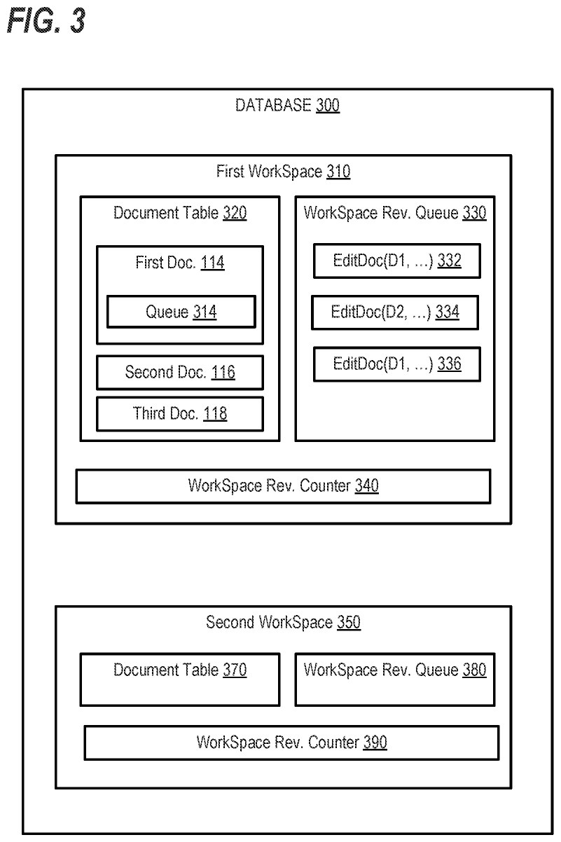

FIG. 3 is a block diagram of an example database 300 configured to store workspaces with separate revision counters using the computing device of FIG. 2. In the embodiment shown in FIG. 3, the database 300 generally corresponds to the database 108a and includes the first document 114, the second document 116, and the third document 118. In other embodiments, the database 300 includes one, two, four, or more documents.

In various embodiments, the database 300 includes a first workspace 310 having a document table 320, a workspace revision queue 330, and a workspace revision counter 340. The first workspace 310 represents a shared repository of a plurality of documents. In some scenarios, the repository is associated with a corporation, business unit, user group, or other entity. The plurality of documents may be of the same or different types in various embodiments, for example, spreadsheet documents, text documents, presentation documents, or other suitable document types. In an embodiment, the workspace 310 is configured to store the plurality of documents (i.e., documents 114, 116, and 118), or suitable data structures associated with the documents, in the document table 320.

The workspace revision counter 340 (or “workspace level revision counter”) is configured to be shared by the plurality of documents and indicates a revision state of the plurality of documents at any given point in time. In other words, the workspace revision counter 340 indicates a revision state of the plurality of documents as an integral data unit, as opposed to separate document revision counters for individual documents (“document level revision counters”). The workspace revision counter 340 is a workspace level revision for grouping the revision of all workspace content at any given point in time within a workspace. By sharing the workspace revision counter 340 among the plurality of documents, a change or revision to any single document causes an increment to the workspace revision counter 340. As an example, when a first change to a first document in the workspace 310 increments the workspace revision counter from 7 to 8, then a second change to a second document in the workspace 310 occurring after the first change increments the workspace revision counter 340 from 8 to 9. In a further example, the workspace revision counter 340 is incremented from 9 to 10 when a third change to the first document is requested.

The workspace revision queue 330 is configured to store revisions to the plurality of documents, more specifically, requests for revisions. The workspace revision queue 330 is shared by the plurality of documents and stores revisions to different documents of the plurality of documents. In various embodiments, the workspace revision queue 330 is a queue for ordering requests for revisions in an linear fashion across the entire workspace. In the embodiment shown in FIG. 3, using the above example, the first change to the first document, the second change to the second document, and the third change to the first document are queued as revisions 332, 334, and 336. In an embodiment, the computing device 200 processes or performs the revisions in the workspace revision queue 330 in a first in, first out (FIFO) manner. In other embodiments, the computing device 200 prioritizes at least some of the revisions, for example, based on a priority level of the corresponding document to be revised, a priority level of a user that requested the revision, or other suitable criteria. In some embodiments, the computing device 200 groups at least some of the revisions in the workspace revision queue 330, for example, according to whether the revisions can be performed in parallel.

In the embodiment shown in FIG. 3, the database 300 also includes a second workspace 350 having a document table 370, a workspace revision queue 380, and a workspace revision counter 390 (analogous to the document table 320, the workspace revision queue 330, and the workspace revision counter 340). In some embodiments, the database 300 is configured to provide a separate workspace for different pluralities of documents, for example, for different corporations, business units, user groups, or other entities.

In some embodiments, the database 300 includes a document revision queue for one or more of the plurality of documents. The document revision queue is configured to store temporary copies of revision and is not shared among the plurality of documents, but is instead specific to a particular document. In an embodiment, for example, the first document 114 includes a document revision queue 314. The document revision queue allows for separate versions or branches of a document to be maintained concurrently, as described herein. In an embodiment, the document revision queue is specific to a locked section of a document where the locked section is a section of the document that is restricted from editing by users outside of an editing group.

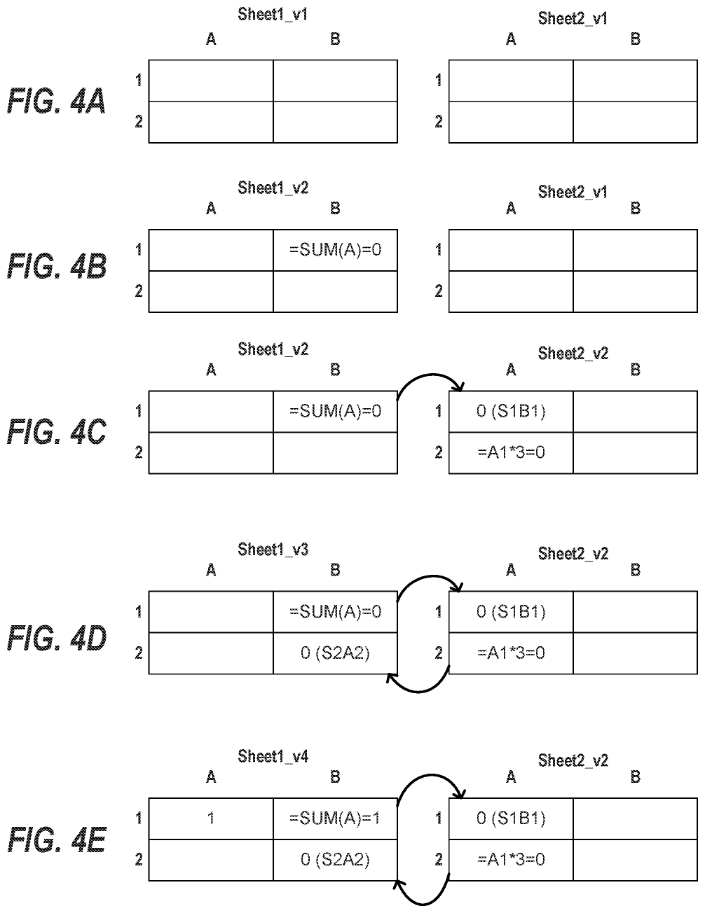

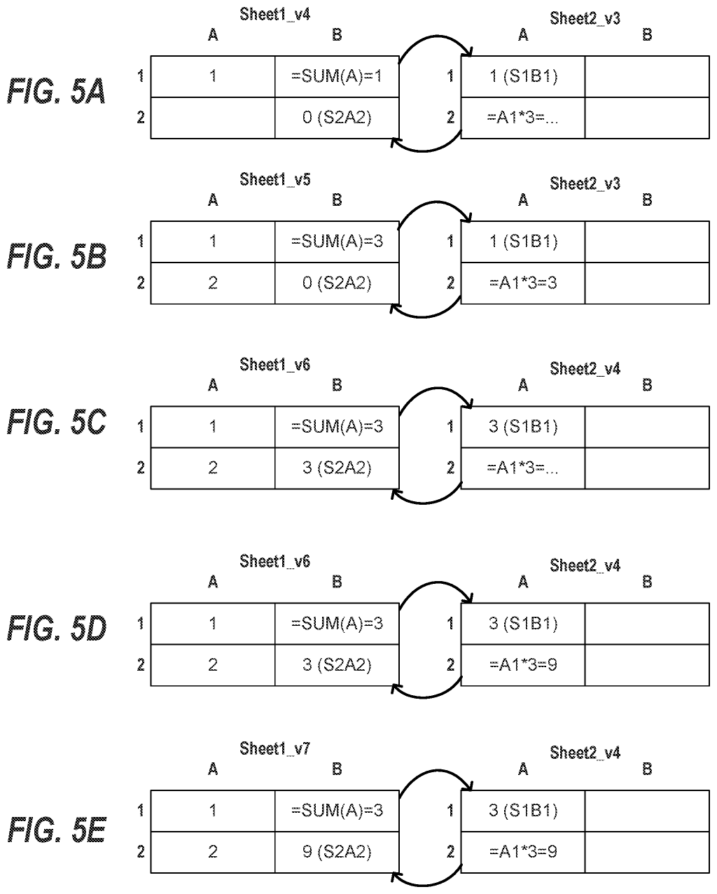

FIGS. 4A to 4E and FIGS. 5A to 5E are diagrams showing a sequence of timeslices for revisions to spreadsheets with cells having formula dependencies and linking dependencies using document revision counters. In the embodiment shown, the sequence shows revisions to a first spreadsheet document (referred to herein as “Sheet1”) and a second spreadsheet document (“Sheet2”) with versions indicated as “v1”, “v2”, and so on. Notably, the version numbers of the documents are independent of each other. For ease of description, only two columns (“A” and “B”) and two rows (“1” and “2”) are shown in FIGS. 4A to 4E and FIGS. 5A to 5E.

FIG. 4A shows an initial state of the documents with both the first document and the second document at version 1 (“Sheet1_v1” and “Sheet2_v1”) with empty cells. At FIG. 4B, Sheet1 has been modified and advances to revision 2 (“v2”) to include a formula in cell B1, specifically, a summation of the values in column A (“=SUM(A)=0”). Since cells A1 and A2 are empty, the summation of cell B1 of Sheet1 in FIG. 4B is zero. At FIG. 4C, Sheet2 has been modified and advances to revision 2, where cell A1 of Sheet2 contains a link to cell B1 of Sheet1 (the link is represented by “S1B1”) and cell A2 contains a formula that relies upon cell A1 (“=A1*3=0”). The link indicates that cell B1 of Sheet1 is a source element for cell A1 of Sheet2, which is a destination element. At FIG. 4D, Sheet1 has been modified and advances to version 3 (“v3”), where cell B2 contains a link to cell A2 of Sheet2 (the link is represented by “S2A2”). In other words, cell A2 of Sheet2 is the source of the link, and cell B2 of Sheet1 the destination of the link.

As used herein, a link is a reference, pointer, or data structure that refers to linked content (or the location of the linked content), while linked content is a set of content, for example, a set of one or more characters or numbers, a set of one or more sentences, a set of one or more paragraphs, a set of one or more cells within a spreadsheet, a set of one or more images, or various combinations thereof. For example, in FIG. 4C, the value 0 in cell A1 of Sheet2 is the linked content, and “S1B1” is a representation that indicate that cell A1 of Sheet2 contains a link. Although “S1B1” and “S2A2” are used to represent links in FIGS. 4C to 4E and 5A to 4E, the user interface may not display these representations. In various implementations, no visual indicator or different visual indicators (e.g., icons, underlining, different font color or font face, different background color, a box that surrounds the link, etc.) may be used to indicate the existence of a link, the source of a link, or the destination of a link. In other embodiments, a user may need to perform another gesture on the user interface (e.g., hover, right click, double click, etc.) to trigger the display of the source(s) or destination(s) of a link (e.g., via a pop-up panel or side panel). In an embodiment, the linked set of content contains a plurality of elements (i.e., characters, cells, paragraphs, etc.) that appear consecutively within a document, for example, cells A4 through A7 of a spreadsheet or sentences one through five of a text document. In another embodiment, the linked set of content contains a plurality of elements that do not appear consecutively, for example, cells B18:C20 of a spreadsheet (i.e., cells B18, B19, B20, C18, C19, and C20).

At FIG. 4E, Sheet 1 has been modified and advances to version 4 (“v4”), where cell A1 has a value of 1 and cell B1, based on its formula, has its displayed value changed to 1. In some scenarios, the link of cell A1 in Sheet2 is not immediately updated, for example, due to processing delays associated with identifying when a source element has changed. Accordingly, at the timeslice shown in FIG. 4E, Sheet2 has not yet been updated to a new version.

At FIG. 5A, the link of cell A1 in Sheet2 has been updated to include the appropriate value from source element B1 of Sheet1 (“1”), cell A2 in Sheet2 is being processed to calculate its formula, and Sheet2 advanced to version 3. In some scenarios, the formula in cell A2 is relatively complex and may have a long processing time (e.g., several minutes or more) before its value has been determined. In other scenarios, the formula may refer to an external source (e.g., a document outside of the workspace 310) that may have reduced availability or delayed updates, for example, by being stored on a remote computer. In still other scenarios, the formula may include a link to another “busy” document that is being used by many other users so that access to its data is delayed.

At FIG. 5B, the formula in cell A2 of Sheet2 has been calculated, a value of “2” has been inserted in cell A2 of Sheet1, the formula in cell B1 of Sheet1 is updated to a value of 3, and Sheet1 has advanced to version 4 (“v5”), but the link in cell B2 of Sheet1 has not yet been updated with the result of the formula in cell A2 of Sheet2. At this timeslice, Sheet1 is inconsistent with itself because the value of cell A2 in Sheet2 has not propagated to cell B2 of Sheet1. Moreover, Sheet2 is not consistent with Sheet1 because cell A1 of Sheet2 has not been updated with the updated value (“3”) of cell B1 of Sheet1.

At FIG. 5C, cell B2 of Sheet1 has been updated to the most recent confirmed value of its link to cell A2 of Sheet2 and Sheet1 advances to version 6 (“v6”). Additionally, cell A1 of Sheet2 is updated to the most recent value of source cell B1 and Sheet2 advances to version 4 (“v4”). At FIG. 5D, cell A2 of Sheet2 has been calculated, but the value is not propagated to cell B2 of Sheet1 until FIG. 5E.

One solution to the problem of propagating values, either through formulas or links, is to utilize the workspace revision counter 340. Although the workspace revision counter 340 may be incremented more often and more quickly than individual document revision counters, the workspace revision counter 340 provides a single value that can be referenced to refer to a single timeslice for all documents in the workspace 310 where all values have been propagated.

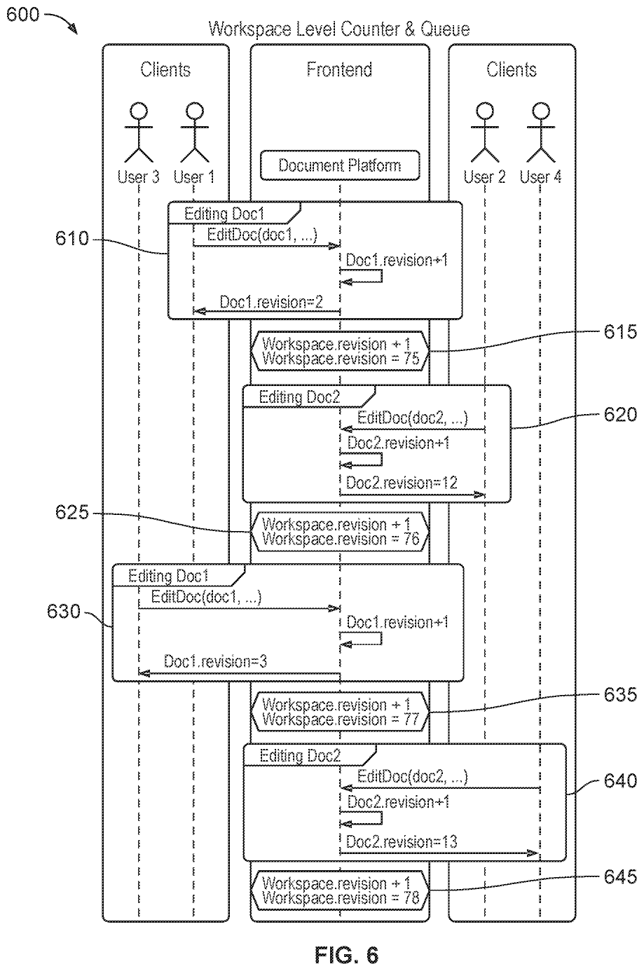

FIG. 6 is a flow diagram showing a sequence 600 of revisions to documents using a workspace revision counter, for example, the workspace revision counter 340, according to an embodiment. In the embodiment shown in FIG. 6, first and second documents (“Doc1” and “Doc2”) are provided for editing to various clients (including Users 1, 2, 3, and 4) by a frontend user interface (“frontend”). In some embodiments, the frontend user interface is provided by the first computing device 100, the fifth computing device 106, or another suitable computing device. In some embodiments, the clients utilize respective ones of the computing devices 104a, 104b, 104c. In the embodiment shown in FIG. 6, User1 and User3 modify the first document, while User2 and User4 modify the second document, via respective user interfaces. Although only two documents and four clients are shown, in other embodiments, the frontend may provide hundreds of documents to hundreds of clients concurrently.

During block 610, User1 sends a request for a revision to the first document (“EditDoc(doc1, . . . )”) and the request is received by the frontend. In some scenarios, the request includes one, two, three, or more revisions. The frontend causes the revision to be performed on the first document, for example, by updating the first document within the database 108a, and increments a document revision counter (“Doc1.revision+1”). The frontend provides the updated document revision counter (“2”) to the User1.

During block 615, the frontend increments the workspace revision counter 340, resulting in a new value of “75”. Although the most recent revision incremented the document revision counter of the first document to “2”, the workspace revision counter 340 is utilized for each document in the workspace 310, so its value is higher than the document revision counter.

During block 620, User2 sends a request for a revision to the second document (“EditDoc(doc2, . . . )”) and the request is received by the frontend. The frontend causes the revision to be performed on the second document, for example, by updating the first document within the database 108a, and increments a document revision counter (“Doc2.revision+1”). The frontend provides the updated document revision counter (“12”) to the User2.

During block 625, the frontend increments the workspace revision counter 340, resulting in a new value of “76”. Notably, revisions to both the first document and the second document result in updates to the same counter, specifically, the workspace revision counter 340. Subsequent revisions to the first document at block 630 and to the second document at block 640 include increments to the respective document revision counters and are also followed by updates to the workspace revision counter 340 at blocks 635 and 645.

In another embodiment, if a first document contains the source element of a link and a second document contains the destination element of the link, then when a user sends a request to edit the source element of the link (e.g., linked content or other properties of the link) in the first document, the request will also trigger a request to edit the destination element of the link in the second document. In other words, when a user makes a revision to the source element of the link in the first document, the revision is propagated to the destination element of the link in the second document. In this instance, the document revision counter of the first document will increment by 1, the document revision counter of the second document will increment by 1, and the workspace level counter will also increment by 1.

Cloud-based document collaboration platforms tend to be fully open and collaborative. That is, all users who are invited to edit a document (e.g., text document, graphics-based document, spreadsheet, or a hybrid of one or more of the foregoing) are able to see one another's edits in real time or nearly real time. However, there are many scenarios in which one or more users would prefer not to share their draft work product with other collaborators. In these scenarios, the user (or group of users) may create a branch of the document, or a branch of a portion thereof (e.g., a section of a document), where read and/or write access to the branch is limited to themselves only (a “private user”) or to themselves and any additional users (a “private group”). Once a section becomes private, users other than the private user or those not within the private group will not be able to see additional edits being made but will only see the state of the section as it was just prior to being taken private. The private user or a user within the private group (assuming they have sufficient permission) can choose to make the edits public, which unlocks the private section and allows the rest of the collaborators to view the changes and to make their own edits to the section if desired.

In an embodiment, edits to the document are managed through the use of a causal tree or causal graph, and when a section of the document is taken private, the document collaboration system creates a copy of the relevant segment or segments of the causal tree or causal graph, uses the segment or segments to keep track of the edits and, when the section is subsequently made public, merges the segment or segments into the original causal graph.

In another embodiment, edits to the document are managed through the use of an Rtree (also referred to herein as “R-Tree”), and when a section of the document is taken private, the document collaboration system creates a copy of the relevant segment or segments of the Rtree, uses the segment or segments to keep track of the edits and, when the section is subsequently made public, merges the segment or segments into the original Rtree.

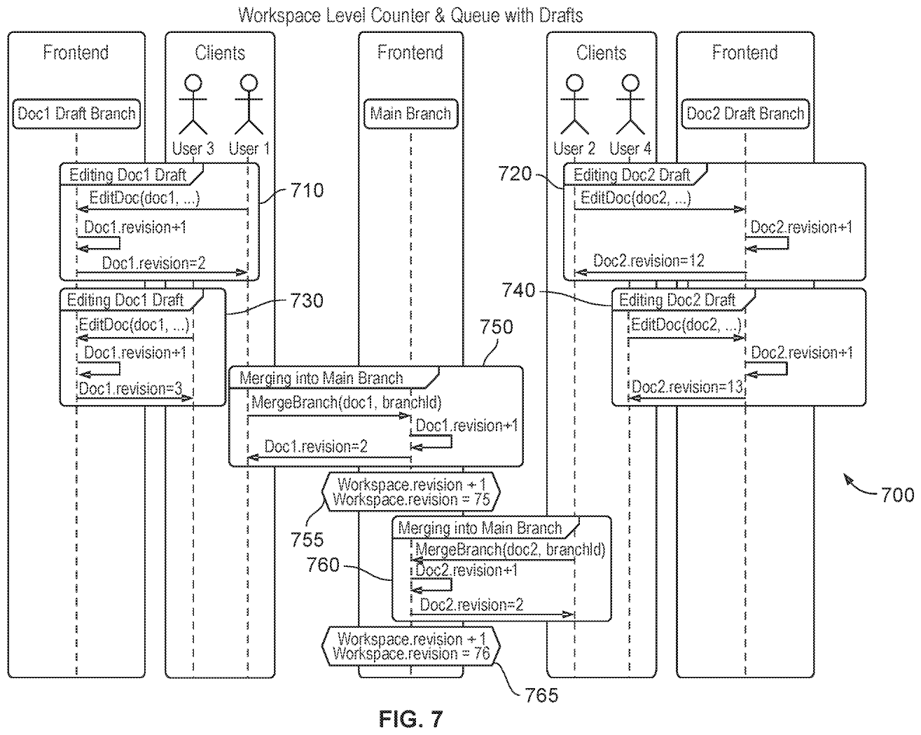

FIG. 7 is a flow diagram showing a sequence 700 of revisions to documents having separate branches using a workspace revision counter and document revision counters, for example, the workspace revision counter 340. The embodiment shown in FIG. 7 is similar to that of FIG. 6, where first and second documents (“Doc1” and “Doc2”) are provided for editing to various clients (including Users 1, 2, 3, and 4) by a frontend user interface (“frontend”).

In the embodiment of FIG. 7, the revisions to the first and second documents are initially stored in a separate branch that may be combined with a main branch at a later time, discarded, or maintained separately from one or more other branches. As an example, a secondary branch of the first document 114 may be edited and reviewed by a user and changes by the user may be stored and managed in the document revision queue 314 without affecting a main branch of the first document 114. When the changes from the user are to be finalized and incorporated into the main branch (e.g., to publish an update to a publicly available document), the changes to the document may be incorporated into the main branch, for example, by merging or rebasing. In various embodiments, the main branch and any secondary branches are identified by respective branch identifiers (“branch IDs”), for example, a unique identifier, that allow revisions in a secondary branch to be incorporated into a main branch, revisions in a main branch to be incorporated into a secondary branch, etc.

Merging generally corresponds to a process of comparing a secondary branch to a main branch and making any needed changes to the main branch to be consistent with the secondary branch. Rebasing generally corresponds to a process of making the changes that were made on the secondary branch (relative to a common earlier base), but instead using a “sibling” branch as the new base to be modified. In other words, rebasing effectively “replays” changes from the secondary branch (e.g., stored in the document revision queue 314) onto another branch sequentially in the order they were introduced, whereas merging takes the endpoints of the branches and simply merges them together.

In the embodiment shown in FIG. 7, the first document and the second document have their own respective secondary branches (“Doc1 Draft Branch” and “Doc2 Draft Branch”). However, in other embodiments, two or more documents within a workspace are part of a same branch. In some embodiments, a branch for an entire workspace is created and later merged or rebased with another branch, or maintained separately.

At block 710 and block 730, respectively, User1 and User2 request revisions to the first document, analogously to blocks 610 and 630. Similarly, at blocks 720 and 740, User2 and User4 request revisions to the second document, analogously to blocks 620 and 640. The revisions corresponding to the first document are stored in the document revision queue 314, in an embodiment, and the revisions corresponding to the second document are stored in a corresponding document revision queue (not shown). In some other embodiments, the document revisions for the first document and the second document are stored in a same database or central repository, but are flagged as being limited to a particular branch, for example, using a branch identifier that uniquely identifies the branch.

At block 750, User1 requests a merge of the secondary branch of the first document with the main branch and the revisions stored in the document revision queue 314 are merged or rebased with those in the main branch. At block 755, the frontend increments the workspace revision counter 340. In this embodiment, the separate revisions of the first document at blocks 710 and 730 are combined into a same request for a revision and correspond to a same revision number (“75”) for the workspace 310. Similarly, the separate revisions of the second document at blocks 720 and 740 are combined into a same request (block 760) for a revision and correspond to a same revision number (“76”, block 765) for the workspace 310. The requests at blocks 750 and 760 identify the revisions to be incorporated into the main branch by using a branch identifier that corresponds to the branch.

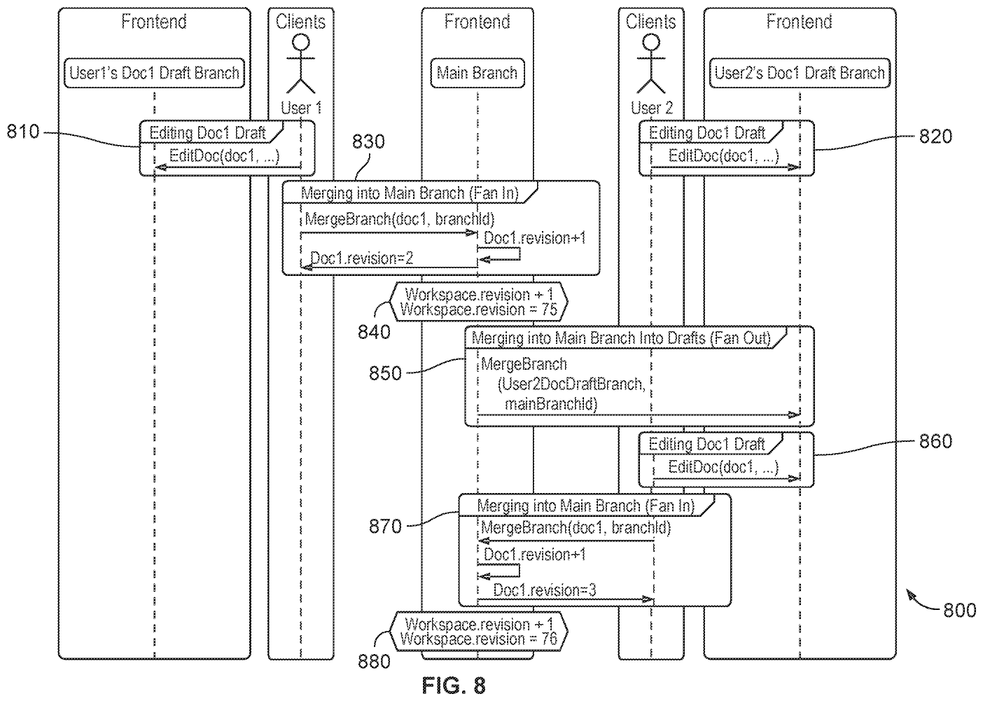

FIG. 8 is a flow diagram showing a sequence 800 of revisions to documents and integration of those revisions into other branches using the workspace revision counter 340, according to an embodiment. In the embodiment shown in FIG. 8, a first document (“Doc1”) is provided for editing to various clients (including Users 1 and 2) by a frontend user interface (“frontend”). In some embodiments, the frontend user interface is provided by the first computing device 100, the fifth computing device 106, or another suitable computing device. In some embodiments, the clients utilize respective ones of the fourth computing devices 104a. In the embodiment shown in FIG. 8, User1 and User2 modify the first document via respective user interfaces. Although only one documents and two clients are shown, in other embodiments, the frontend may provide hundreds of documents to hundreds of clients concurrently.

At block 810, the first user (User1) makes revisions to a secondary branch of the first document (e.g., a “private” branch) that are stored separately from other revisions by the second user (User2), which are performed at block 820. At block 830, the first user requests that the changes from their secondary branch be incorporated into the main branch in a manner similar to that described above with respect to block 750. At block 840, the frontend increments the workspace revision counter 340.

In contrast to the merging of a secondary branch into the main branch (e.g., a “fan-in” action), at block 850, the revisions to the main branch that were fanned in are “fanned out” to the secondary draft of the second user. In various embodiments, the fanning out process is a merge process or a rebase process, as described above.

At block 860, the second user (User2) makes revisions to a secondary branch of the first document that are stored separately from the revisions by the first user. At block 870, the second user incorporates the changes from their secondary branch into the main branch in a manner similar to that described above with respect to block 830. At block 880, the frontend increments the workspace revision counter 340.

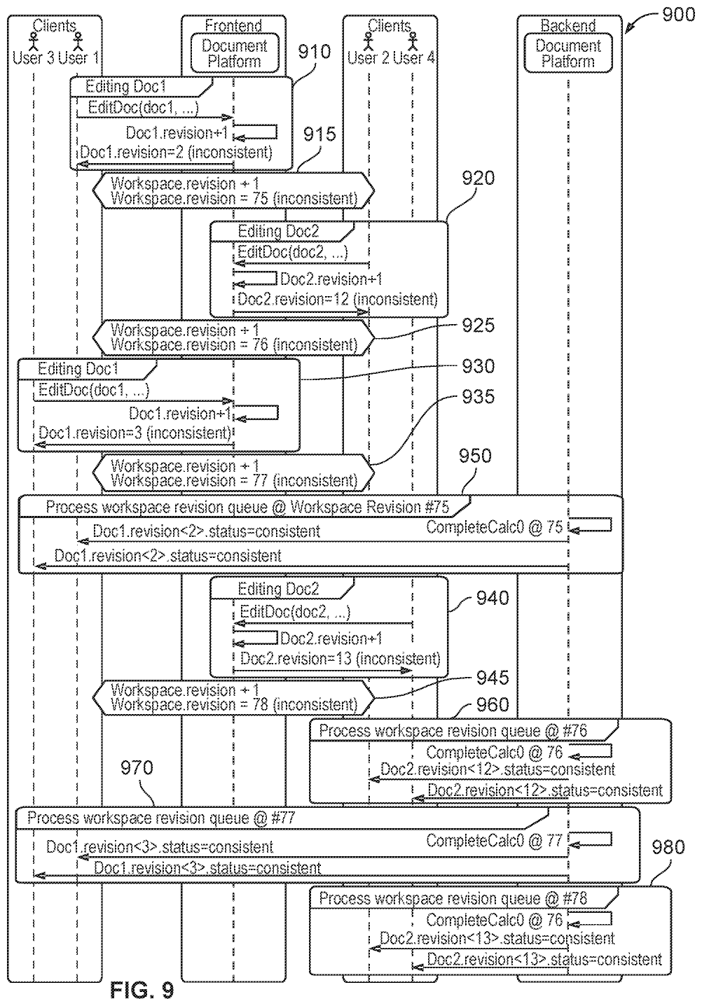

FIG. 9 is a flow diagram showing a sequence 900 of revisions to documents using a workspace revision counter and workspace revision queue where temporary revisions are displayed, according to an embodiment. In some scenarios, utilization of the workspace revision queue 330 reduces performance (e.g., longer processing times, longer queue times before a revision is performed) due to higher memory requirements for data structures associated with the workspace 310. In an embodiment, for example, a single RTree or causal tree is shared for the plurality of documents in the workspace 310 and has a larger size than separate RTrees for the documents. Additionally, contention for access to the RTree by different documents being revised at the same time may increase the queue times for a revision to be processed.

In the embodiment shown in FIG. 9, the computing device 200 is configured to perform “optimistic” revisions at the document level, but identify those revisions as being “inconsistent” within the user interface until the revision has been processed and determined to be consistent at the workspace level. The optimistic revisions are revisions that are received from a user for a displayed document (e.g., a secondary branch displayed on a user interface 104a), performed for the displayed document and updated on the user interface 104a, but without fully updating formulas or links in the displayed document that refer to other documents, other sections of documents, or external sources. Optimistic revisions provide improved feedback to the user (i.e., near real-time, without having to wait for changes to propagate through the workspace revision queue), but may be incorrect if they rely on the results of a formula calculation or link that has not completed.

As one example, a cell B1 in a first sheet (S1B1) and a cell B3 of a second sheet (S2B3) contains formulas as follows:

S1B1=SUM(S1A1,S1A2,S2B3)

S2B3=S1A1*3

where S1A1 corresponds to a cell A1 of the first sheet with an initial value of “2”, S1A2 corresponds to a cell A2 of the first sheet having an initial value of “5”. In this example, the cell S2B3 has an initial value of “6” (2*3) and the cell S1B1 has an initial value of “13” (2+5+6). When the user revises cell S1A1 to a value of “4”, an optimistic revision indicates a new value of “15” (4+5+6), using the updated value of cell S2A1 but without an update to the value referenced in the second sheet (S2B3). In this example, the value of “15” is shown, but with a temporary identification on the displayed document that indicates that the value is a temporary revision, not a final revision (i.e., with an updated value from cell S2B3). Once the final revision has been propagated, where S2B3 is updated to “12” (4*3) and S1B1 is updated to 21 (4+5+12), the temporary identification is removed. Examples of a temporary identification include a different font color or font face, a different background color, a box that surrounds the value, underlining, or other suitable visual indication.

At blocks 910, 920, 930, and 940, various users revise first and second documents and send requests for the revisions to the frontend, in a manner similarly to that described above with respect to blocks 710, 720, 730, and 740. In the embodiment of FIG. 9, however, the revisions at blocks 910, 920, 930, and 940 are optimistic or temporary until the computing device 200 has finalized the revisions, for example, by updating formulas and links contained within an RTree for the workspace 310. At blocks 910, 920, 930, and 940, the temporary revisions are marked as “inconsistent,” as discussed above. Moreover, updates to the workspace revision queue 330 are marked as inconsistent until the revisions have been finalized.

In some embodiments, a separate process is performed for finalizing the revisions using the workspace revision queue, for example, a write-behind consistency process. The write-behind consistency process traverses the entirety of the RTree for the workspace 310 and updates formulas, links, or both formulas and links. In an embodiment, the frontend is provided by the productivity server 100 and the write-behind consistency process is performed by the database server 106. When the write-behind process is complete, the database server 106 marks the workspace revision queue 330, or a particular revision therein, as being consistent. In the embodiment shown in FIG. 9, the write-behind consistency process is shown performing separate final revisions for blocks 910, 920, 930, and 940 at blocks 950, 960, 970, and 980, respectively.

In some embodiments, causing the revision to be performed includes queuing a temporary copy of the revision in a document revision queue that is specific to the document corresponding to the revision. In an embodiment, for example, the document revision queue corresponds to the document revision queue 314. A temporary revision is performed on a computing device that displays a secondary branch of the document corresponding to the revision, without performing a revision on a corresponding main branch of the document. In an embodiment, for example, the productivity server 100 performs the temporary revision on a branch of the first document at block 910, without performing a final revision at block 950 (i.e., before the final revision has been performed). In other embodiments, the temporary revision corresponds to the blocks 920, 930, or 940 of FIG. 9. The revision is queued as a final revision in the workspace revision queue 330 and performed on the main branch, for example, corresponding to blocks 950, 960, 970, or 980 of FIG. 9.

In some embodiments, a received request for a revision indicates a revision to two or more documents. In an embodiment, for example, the request is for a revision to a link where the revision corresponds to a source element within a first document and a destination element within a second document. The link revision is initially queued in the first document revision queue that is specific to the document containing the source element of the link (e.g., the document being edited by the user that makes the request). In an embodiment, this document revision queue is processed by the frontend provided by the productivity server 100. The link revision is initially identified as being “inconsistent” until the write-behind consistency process, performed by the database server 106, further processes the revision and determines that the revision is consistent with other revisions, links, and/or formulas. In an embodiment, the link revision is queued in the workspace revision queue, the write-behind consistency process traverses the RTree for the workspace 310 for the link revision, and queues the link revision in a document revision queue that is specific to the second document containing the destination element.

In some embodiments, revisions or updates to the workspace 310 that originate outside of the workspace 310 are also handled using the write-behind consistency process. In this way, an update to an external document (e.g., outside of the workspace 310) that is relied upon by a document within the workspace 310 is associated with a final revision and reference number for the workspace revision counter 340. In various embodiments, the external document is located on a remote server, cloud service, in a different workspace (e.g., in the workspace 350), or other suitable location.

As discussed above, in some embodiments, the computing device 200 utilizes an RTree as a data structure to store electronic documents of the workspace 310. In an embodiment, the computing device 200 utilizes the RTree for maintaining formulas that reference different cells. In another embodiment, the computing device 200 utilizes the RTree for maintaining both formulas and links to different cells. In this embodiment, a single RTree is utilized for maintaining formulas and links throughout the plurality of documents of the workspace 410. This approach improves detection of circular references across all documents within the workspace 310 and also improves the flow of values from one document to another document over links and formulas. In some embodiments, the computing device 200 maintains separate RTrees (e.g., one or more RTrees per document), but links the RTrees by utilizing a common reference time.

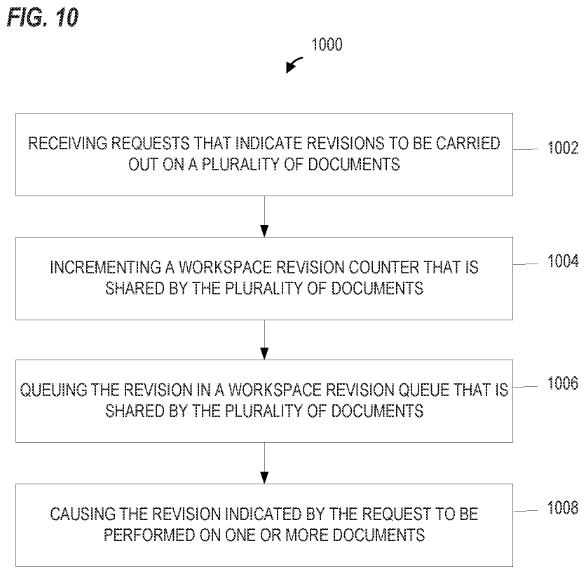

FIG. 10 is a flowchart illustrating an example method, implemented on a server, for maintaining links and revisions for a plurality of documents, according to an embodiment. In some embodiments, the method 1000 is implemented by the productivity server 100 of FIG. 1, which interacts with the database server 106 and the client devices 104. FIG. 10 is described with reference to FIG. 1 for explanatory purposes. In other embodiments, however, the method 1000 is implemented by another suitable computing device.

At block 1002, requests are received that indicate revisions to be carried out on the plurality of documents. In an embodiment, the plurality of documents corresponds to the plurality of documents in the document table 320 (FIG. 3). In some embodiments, at least one of the requests correspond to revisions for different documents of the plurality of documents, for example, the first document 114 and the second document 116. In various embodiments, the requests correspond to blocks 610, 620, 630, or 640 of FIG. 6, blocks 710, 720, 730, 740, 750, or 760 of FIG. 7, blocks 810, 820, 830, 850, 860, or 870 of FIG. 8, or blocks 910, 920, 930, or 940 of FIG. 9.

At block 1004, a workspace revision counter that is shared by the plurality of documents is incremented. In an embodiment, the workspace revision counter indicates a revision state of the plurality of documents. In some embodiments, the workspace revision counter corresponds to the workspace revision counter 340. In various embodiments, incrementing the workspace revision counter 340 corresponds to blocks 615, 625, 635, or 645 of FIG. 6, blocks 755 or 765 of FIG. 7, blocks 840 or 880 of FIG. 8, or blocks 915, 925, 935, or 945 of FIG. 9.

At block 1006, the revision is queued in a workspace revision queue that is shared by the plurality of documents. In an embodiment, the workspace revision queue corresponds to the workspace revision queue 330.

At block 1008, the revision indicated by the request is caused to be performed on one or more documents of the plurality of documents that correspond to the request.

In some embodiments, the method 1000 further includes displaying a temporary identification that corresponds to the temporary revision on the displayed document and indicates that the temporary revision is not the final revision. The temporary identification is removed from the displayed document when the final revision has been performed. In an embodiment, for example, a temporary revision is shown on a computing device using a different font color or font face, a different background color, a box that surrounds the value, underlining, or other suitable visual indication as the temporary identification at block 910, and the temporary identification is removed at block 950. In some embodiments, at least some user interface features of a user interface on which the document is displayed are disabled while at least some temporary identifications are displayed. In an embodiment, for example, user interface features such as generating a report based on the plurality of documents, exporting the plurality of documents, or other actions are temporarily disabled until the revisions have been finalized.

In an embodiment, the method 1000 further includes receiving a revision for data that is external to the plurality of documents and linked from at least one of the plurality of documents. In an embodiment, the external data corresponds to data from an external workspace, for example, the workspace 350. In another embodiment, the external data corresponds to data from a remote server, cloud service, or other suitable location. The workspace revision counter is incremented based on the revision for the external data. The revision for the external data is queued in the workspace revision queue, i.e., the workspace revision queue 330.

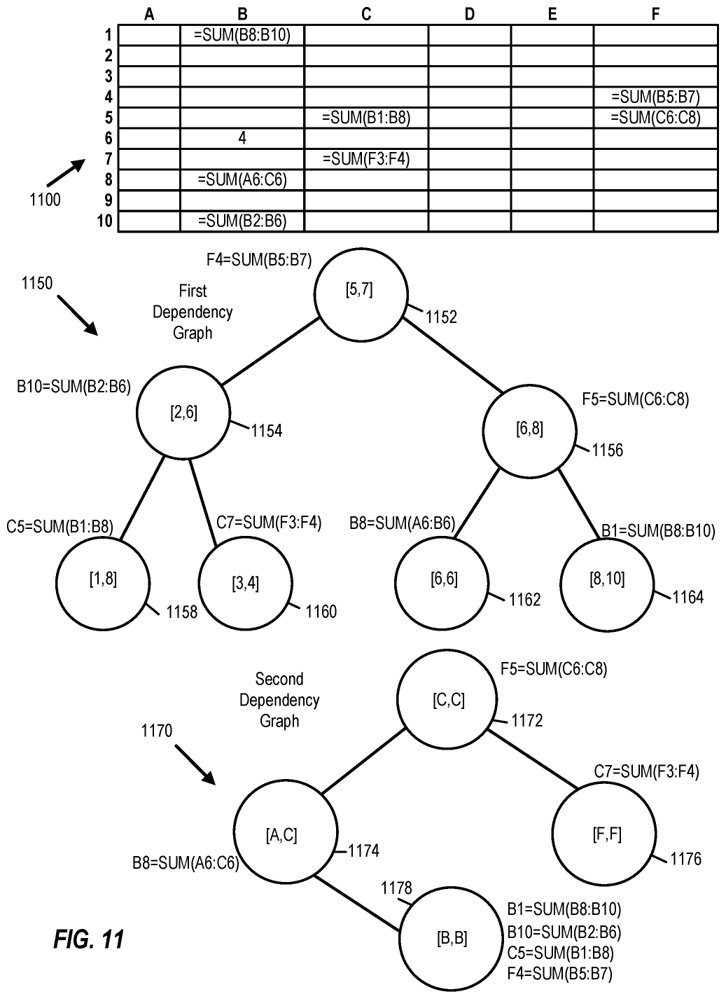

FIG. 11 is a diagram of an example spreadsheet and dependency graphs, according to an embodiment. The term “graph” as used herein refers to a representation of a set of objects, in which at least some pairs of objects in the set are connected to one another by one or more edges. Each of the objects occupies a vertex of the graph. An “interval-based dependency graph” or “dependency graph” as used herein is a data structure that represents the interdependencies of a set of formulas or other mechanisms of reference between objects by way of a graph, with the instantiation of each vertex being referred to as a “node.” Possible implementations of a dependency graph include an interval tree and a skip list. The term “reference element” as used herein is an electronically-stored object (such as a formula, function) that establishes a unidirectional or bidirectional link between at least two objects (such as between at least two cells of a spreadsheet or at least two cells of different spreadsheets). An example of a reference element is a formula contained in a cell of a spreadsheet, wherein the formula refers to (relies upon) the value contained in some other cell of the spreadsheet (or a cell of a different spreadsheet or which, itself, may be the result of a formula calculation) in order to calculate a result. The term “table” as used herein is a collection of data organized into rows and columns. Examples of tables include a spreadsheet and a worksheet. A table may be embedded within any sort of document. Finally, “document” as used herein includes any type of electronically stored document, including text documents, spreadsheets, presentations, drawings, diagrams, and composite documents that include elements of different types of documents.

The spreadsheet shown in FIG. 11, generally labeled 1100, has a number of cells that are organized into rows and columns. The spreadsheet 1100 would ordinarily not display the formulas within the cells, but instead would display the evaluated result of the formulas with the cells and the formulas above within a formula bar. However, for ease of reference, the formulas are shown in FIG. 11 inside the respective cells they govern. Each cell has an element ID that the processor 152 may use to retrieve the contents of the cell, including the formula of the cell (if it has a formula) and the value contained in the cell (either a constant or the calculated result of a formula). Although the only type of formula shown in FIG. 11 is a “sum” formula, it is to be understood that other types of formulas are possible. Additionally, a cell might contain a link to another cell, and such a link could be treated the same way as a formula for the techniques described herein.

According to an embodiment, for each cell in FIG. 11, the processor 152 uses a numerical value to represent the row (starting with zero, so that row one is represented by the value zero, row two is represented by the value one, row three is represented by the value two, etc.) and a numerical value to represent the column (starting with zero, where column A is represented by the value zero, column B is represented by the value one, column C is represented by the value two, etc.). The processor 152 represents each interval as a starting point (inclusive) followed by an ending point (exclusive). For example, processor 152 represents a column interval from column A to column A by the interval [0,1). In an embodiment, the processor 152 uses these numerical values to calculate the size of the interval as the difference between the ending point to the starting point. For example, the size of the column interval from column A to column A is 1−0=1. For the sake of clarity, however, the intervals of rows and columns will hereafter be described in terms of rows and column notations of FIG. 11 with inclusive endpoints. Thus, for example, the range of cells from A6 to C6 will be said to include the row interval [6,6] and the column interval [A,C].

In an embodiment, when the computing device (e.g., the first computing device 100) receives the input of a formula into a spreadsheet (e.g., from the second computing device 104 via the network 102), the processor 152 analyzes the formula to determine which cells the formula references, populates the data structure (e.g., a bit array) with data representing those cells, and associates the cell into which the formula has been input with the appropriate nodes of the dependency graphs 1150 and 1170 (or an RTree). In some examples, the processor 152 inserts a node into a range tree (not shown) corresponding to the cell location (e.g., A6) into which the formula is input. Additionally, the processor 152 analyzes the range tree and the dependency graphs 1150 and 1170 in order to determine which formulas of the spreadsheet may be carried out in parallel, assign the newly-input formula to a group based on this analysis, and update any previously-assigned groups of other, previously-input formulas based on the analysis. According to various embodiments, the processor 152 carries out these operations in such a way and with such timing that they are complete by the time an event requiring recalculation of the spreadsheet is required (e.g., immediately upon input of the formula).

Possible implementations of the first dependency graph 1150 and the second dependency graph 1170 are shown in FIG. 11. The first dependency graph 1150 in this example is a row interval tree, and the second dependency graph 1170 is a column interval tree. The rows and columns of FIG. 11 are denoted by their actual row and column values for ease of reference. In other implementations, however, the rows and columns would both be numerically represented and start from zero. Associated with each node of the first dependency graph 1150 and the second dependency graph 1170 is at least one cell of the spreadsheet 1100 (whose location and formula are textually shown within the node for convenient reference) that depends on at least one cell that falls within the range of rows or columns represented by the node. This may include, for example, a dependency based on a formula or a dependency based on a link.

Continuing with the first dependency graph 1150, the processor 152 creates and maintains the first dependency graph 1150 to track the rows on which each of the formulas of the spreadsheet 1100 depends. The first dependency graph 1150 in this example includes: a first node 1152 representing the interval of row five to row seven and associated with cell F4; a second node 1154 representing the interval of row two to row six and associated with cell B10; a third node 1156 representing the interval of row six to row eight and associated with cell F5; a fourth node 1158 representing the interval of row one to row eight and associated with cell C5; a fifth node 1160 representing the interval of row three to row four and associated with cell C7; a sixth node 1162 representing row six only and associated with cell B8; and a seventh node 1164 representing the interval of row eight to row ten and associated with cell B1.

The processor 152 creates and maintains the second dependency graph 1170 to track the columns on which each of the formulas of the spreadsheet 1100 depends. The second dependency graph 1170 in this example includes: a first node 1172 representing column C only and associated with cell F5; a second node 1174 representing the interval of column A to column C and associated with cell B8; a third node 1176 representing column F only and associated with cell C7; and a fourth node 1178 representing column B only and associated with cells B1, B10, C5, and F4.

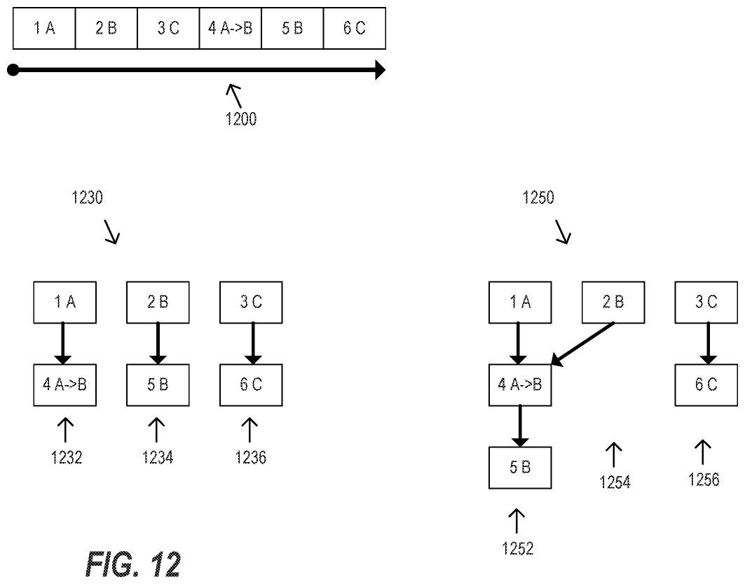

FIG. 12 is a diagram showing an example sequence of pending requests using a workspace revision queue 1200, an example parallel processing graph 1230 for the workspace revision queue 1200, and an example pending request graph 1250 based on a suitable dependency graph (not shown). The pending requests indicate revisions to be carried out on a plurality of documents of a workspace and are referred to herein as a number (1 through 6) representing an initial ordering of the revisions, such as a chronological order (or First In, First Out FIFO order), priority order, or other suitable order, along with a letter (A, B, or C) representing a document within the plurality of documents of the workspace. In the example shown in FIG. 12, the pending requests include a chronological ordering of a revision to document A (1A), a revision to document B (1B), a revision to document C (1C), a revision for documents A and B where a link is created from document A as a source document to document B as a destination document (4A->B), a revision to document B (5B), and a revision to document C (6C).

The workspace revision queue 1200 may be implemented as a durable log or other suitable data structure. Generally, a durable log is a data structure used for recording events, transactions, or revisions to documents or workspaces in a way that ensures durability and persistence in the event of a system failure or crash. In some examples, the workspace revision queue 1200 is configured with write-ahead logging, where each revision is recorded in the workspace revision queue 1200 before the revision is applied to the workspace or its documents. This way, if a failure occurs during the revision, the workspace revision queue 1200 may be used to recover the workspace and documents.

In some examples, the workspace revision queue 1200 is implemented using Kafka as an external commit-log for a database, distributed system, the SaaS platform software 107, or the productivity software 101. Revisions (or requests for revisions) within the commit-log may be flagged as either pending requests indicating revisions to be carried out on the plurality of documents (“uncommitted” entries in the log), or as processed requests indicating revisions that have been carried out on the plurality of documents or workspace (“committed” entries in the log). The revisions may include metadata, such as dependency entries (described below), a time of the revision, a user requesting the revision, etc.

In a workspace having a plurality of documents, provided by the SaaS platform 107 for example, dozens or hundreds of revisions may be received per second from different users or systems. To improve the speed at which these revisions may be performed and displayed to the users, the revisions may be performed in parallel by processors of a distributed system (e.g., multiple instances of the computing device 100, the computing device 106, or other suitable computing devices). To improve consistency in the display of a document, for example, avoiding the display of a first value for a first revision to a field, changing to a second value for a second revision to the field (an intermediate state), and changing to a third value for a third revision to a field all within a span of a few seconds, the revisions may be performed according to dependencies for the field. In this way, the second revision may be held back from processing as depending upon the third revision so that a user sees only the first value and then the third value. Dependencies for fields or documents may be represented by dependency graphs, for example, the dependency graphs 1150 and 1170.

The parallel processing graph 1230 shows one possible arrangement for parallel processing of the pending requests of the workspace revision queue 1200. In the parallel processing graph 1230, the fourth revision (4A->B) is shown as depending from the first revision (TA) for a first processing group 1232, the fifth revision (5B) is shown as depending from the second revision (2B) for a second processing group 1234, and the sixth revision (6C) is shown as depending from the third revision (3C). Generally, each of the processing groups 1232, 1234, and 1236 may be performed independently by three separate processors. However, in some scenarios, revisions that do not directly depend from one another may still result in an intermediate state that is inconsistent. As one such example, the fourth revision (4A->B) indirectly depends from the second revision (2B) because it creates a relationship between documents A and B and as such, performing revisions in a first order of 1A, then 2B, then 4A->B may result in a different intermediate state than when performing the revisions in a second order of 1A, then 4A->B, then 2B. Even when this intermediate state is only displayed for a short time period (e.g., a few seconds or less), a user viewing the documents A and B may be confused about what they are seeing.

The pending request graph 1250 is a graph having nodes that represent pending requests for revisions. The pending request graph 1250 is based on a suitable dependency graph for the documents A, B, and C and, in some scenarios, promotes fairness in performing revisions while managing out of order and/or parallel processing (i.e., different from the sequential ordering of the workspace revision queue 1200). Generally, out of order processing may provide improved responsiveness for users awaiting a visual confirmation of their changes (e.g., having changes they requested shown on their own screen).

Edges of the pending request graph 1250 indicate parent nodes for parent requests and child nodes for child requests that depend from parent requests according to the dependency graph. In the example shown in FIG. 12, the nodes 1A and 2B are parent nodes to a child node 4A->B, the node 4A->B is a parent node to a child node 5B, and the node 3C is a parent node to a child node 6C. In other scenarios, a node (not shown) for a request having no dependency relationships (i.e., no parent and no child relationship) may have no edges.

The pending request graph 1250 may be generated (e.g., by the processor 152) using dependency graphs for the documents A, B, and C. In some examples, the dependency graphs are pre-existing graphs of a workspace, in other words, created before the revisions to be added to the pending request graph 1250 were performed or added to the pending request graph 1250. In some examples, the dependency graphs may be created (or updated) when documents within the workspace are saved, published, modified, or deleted. In other examples, the dependency graphs are created or updated on a schedule (e.g., every other day), after a time period of low activity, after a threshold number of changes to the documents or workspace, or other suitable times. Examples of dependency graphs are shown in FIG. 11 and described above, but other formats or structures of dependency graphs may be used to generate the pending request graph 1250, in other embodiments.

Using the dependency graphs, the processor 152 generates the pending request graph 1250. As shown in FIG. 12, the pending request graph 1250 has three processing groups 1252, 1254, and 1256 with nodes corresponding to pending requests (uncommitted revisions) from the workspace revision queue 1200. Generally, the pending request graph 1250 is generated by adding nodes to the pending request graph (or creating a new graph) where the nodes correspond to at least some pending requests from the workspace revision queue 1200. In some examples, the processor 152 reads one, two, three, or more pending requests from the workspace revision queue 1200 for placement into the pending request graph 1250.

In some examples, the processor 152 generates the pending request graph 1250 using a pessimistic relational impact among the documents within the dependency graphs. For example, while a first field in document A may depend from content in document B and a second field in document A may be independent of document B, a change to the second field may be flagged as dependent from document B. In other words, a single relationship among documents may be sufficient to create a dependency among the documents because dependencies are flagged at a document level, not a field level. In other embodiments, dependencies may be flagged at the field level, cell level, section level, page level, or other suitable level. As another example, the processor 152 may interrogate or analyze a revision to determine a type of the revision (e.g., add or change text, add or change a formula, add or change a link, etc.) and which documents are modified by the revision. The processor 152 may then determine which documents could potentially be modified by the revision (e.g., using a database lookup, dependency graph lookup, etc.) and create a dependency entry for the request. The dependency entry may indicate which

The processor 152 may use the pending request graph 1250 to identify ready requests for processing (i.e., ready to be carried out on the corresponding documents or workspace). Generally, nodes of the pending request graph 1250 are flagged as incomplete before and during processing of the corresponding requests and flagged as complete after processing of the corresponding requests. In various embodiments, the processor 152 identifies ready requests from nodes of the pending request graph 1250 that do not have incomplete parent nodes. As one example, the node 5B is not a ready request until the request for the node 4A->B has been processed and flagged as complete. As another example, the node 4A->B is not a ready request until both the node 1A and the node 2B have been processed and are flagged as complete. A further description for the nodes of pending request graph 1250 is provided below.

Generally, after a request (or revision) has been processed and completed, the corresponding node may be either flagged as complete within the pending request graph 1250, removed from the pending request graph 1250, or flagged and then later removed. In some examples, the processor 152 processes the pending request graph 1250 to identify ready requests when an earlier request is being flagged as complete. For example, when flagging a node as complete, the processor 152 may determine whether any child nodes exist for the flagged node and, if so, identifying those child nodes as ready requests when they have no other parent nodes.

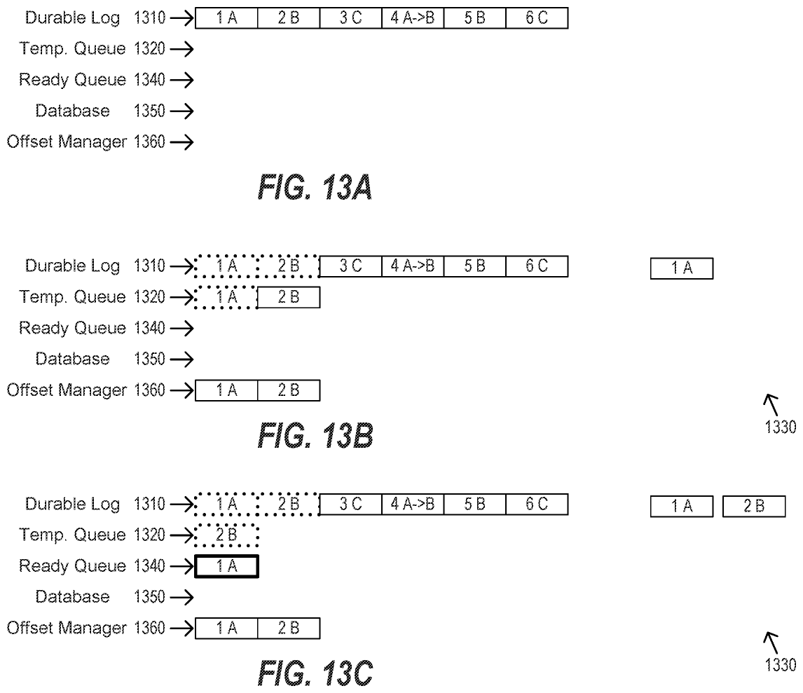

FIGS. 13A-13C, 14A-14C, 15A-15C, 16A-16C, 17A-17C, and 18A-18C are diagrams showing a sequence of examples of a durable log 1310 and pending request graph 1330 for processing of the pending requests of FIG. 12. The durable log 1310 generally corresponds to the workspace revision queue 1200 and comprises six chronological entries (1A, 2B, 3C, 4A->B, 5B, and 6C) for revisions to documents A, B, and C. Generally, the processor 152 reads pending requests from the durable log 1310 and adds nodes for the pending requests to the pending request graph 1330. Pending requests from the durable log 1310 may be organized in a temporary queue 1320 and a ready queue 1340 for processing, in various scenarios. For example, the processor 152 may read a contiguous block of pending requests from the durable log 1310 and place the contiguous block into the temporary queue 1320.

In some examples, the temporary queue 1320 may be stored in memory instead of a database or file for faster access when identifying ready requests and processing the ready requests, as described below. From the temporary queue 1320, the processor 152 may generate the pending request graph 1330 by adding a node to the pending request graph 1330 (or creating a new graph), where the node corresponds to a pending request from the temporary queue 1320. The processor 152 identifies ready requests from nodes of the pending request graph 1330 and moves those pending requests from the temporary queue 1320 to a ready queue 1340. The ready requests may correspond to nodes that do not have incomplete parent nodes, in other words, requests whose parent nodes have already been flagged as complete. In some examples, a ready request may correspond to a node that has one or more parent nodes that have not yet been flagged as complete, but which are estimated to be completed before the ready request would be completed.

Pending requests from the ready queue 1340 may be assigned or distributed to suitable processors to be processed. However, in some scenarios using parallel processing of pending requests, revisions that are requested at a later time may actually be processed and completed before a revision that was requested at an earlier time. In other words, some revisions are completed out of order. For example, some revisions may be more complex and thus more processor intensive, requiring more computing cycles to be completed. As another example, some revisions may be processed by a slower processor or a processor with less memory.

To ensure that the durable log 1310 provides durability and persistence even when requests are completed out of order, revisions are not committed to the durable log 1310 (or flagged as committed) until each earlier revision has also been completed and committed. In this way, there are no gaps of unprocessed requests in the durable log 1310 in the event of a system crash or other issue in service (e.g., a gap where 1A and 3C are committed, but 2B is not committed). For example, request 3C cannot be flagged as committed until both request 2B and request 1A have been committed. In some examples, multiple requests may be flagged as committed as part of a single operation, for example, flagging each of 1A, 2B, and 3C as committed in a single operation. In other examples, multiple requests are flagged separately and sequentially, for example, flagging 1A as committed in a first operation, flagging 2B as committed in a second operations, and flagging 3C as committed in a third operation.

Generally, a portion of the durable log 1310 that has been committed may be tracked using only a single location in the durable log 1310, instead of flagging individual requests as being committed or uncommitted. The single location may be a commit reference that references a next request to be committed or, in other words, a starting location of uncommitted requests within the durable log 1310. The commit reference may be populated with a value corresponding to a request when that request is read from the durable log 1310 during a startup period (e.g., when no requests have been previously read) or from a stored value (e.g., when recovering from a system crash). Updates to the commit reference may be made when the request corresponding to the commit reference is completed and committed to the durable log 1310. For example, the commit reference may be updated to a next adjacent request in the durable log 1310 that has not yet been committed. The commit reference may be stored in a crash-tolerant manner, for example, by writing to a disk or database so that the reference may be recovered in the event of a system crash or other issue. In other examples, the commit reference may be a reference to a last committed request, or other suitable reference for tracking a boundary between committed and uncommitted requests within the durable log 1310.

In some examples, revisions that have been completed but not yet committed (e.g., while waiting on earlier revisions to be completed so as to maintain durability) are temporarily flagged as complete but not flagged as committed in the durable log 1310. In the examples described below, requests for revisions that have been completed but not committed are stored in a database 1350 (e.g., database 108a) or another suitable data structure or repository. Moreover, an offset manager 1360 (or a routine executed by the processor 152) may track the pending requests to determine when a sequential group of pending requests may be flagged as committed according to suitable conditions. In some examples, a sequential group of pending requests may be committed when each of the corresponding revisions have been processed and a first request of the sequential group corresponds to the commit reference (i.e., the first request is the first uncommitted request in the durable log 1310). After being flagged as committed in the durable log 1310, the requests may be removed from the database 1350 and the offset manager 1360.

In FIG. 13A, the entries of the durable log 1310 are pending requests that have not yet been processed and not yet been read or analyzed for processing (e.g., to determine dependencies as described herein), shown as entries in the durable log 1310 with a solid line border. At a time of FIG. 13A, the pending request graph 1330 has not yet been created. As described above, entries of the durable log 1310 are in chronological order.

In FIG. 13B, the processor 152 reads one or more pending requests from the durable log 1310. Generally, the one or more pending requests are at least an earliest, uncommitted request in the durable log 1310 (i.e., request 1A). The one or more pending requests may further include one or more sequential or chronological requests after the earliest, uncommitted request. In the example shown in FIG. 13B, the processor 152 reads two pending requests (1A and 2B, shown as entries in the durable log 1310 with a dotted line border) as the one or more pending requests and places them in the temporary queue 1320. In other examples, the processor 152 may read one, three, four, or more requests from the durable log 1310. In some examples, requests that have been read from the durable log 1310 may be flagged as such in the durable log 1310. In other examples, the requests are flagged in a data structure in memory, for example, to reduce writing to the durable log 1310 and improve access speed.

After reading the pending requests and their placement into the temporary queue 1320, the processor 152 generates the pending request graph 1330 using a dependency graph for documents associated with the durable log 1310. The pending request graph 1330 may generally correspond to the pending request graph 1250 and be generated according to dependency graphs such as graphs 1150 and 1170. Advantageously, the dependency graph is pre-generated to be available as requests are processed from the durable log 1310, which improves the speed with which the pending requests may be placed into the pending request graph 1330 and provided to a processor. In some examples, the graphs 1150 and 1170 are stored in memory instead of a database or file for faster access. At a time of FIG. 13B, the pending request 1A has been placed into the pending request graph 1330 (shown as an entry in the temporary queue 1320 having a dotted line border).

The offset manager 1360 tracks pending requests that have been read from the durable log 1310 and determines when the requests may be flagged as committed within the durable log 1310. In some examples, the offset manager 1360 maintains a list or data structure indicating which pending requests have been read from the durable log 1310 so that a sequential group of pending requests may be committed to the durable log 1310 when appropriate. In the examples described herein, the offset manager 1360 tracks the pending requests from when they are read from the durable log 1310 or placed into the temporary queue 1320 until they are committed to the durable log 1310. At the time of FIG. 13B, the offset manager 1360 tracks the pending requests 1A and 2B. In another example, the offset manager 1360 tracks the pending requests when assigned to a processor. In yet another example, the offset manager 1360 tracks the pending requests only when the pending requests have been completed but cannot be flagged as completed, for example, when waiting for an earlier request to be completed. When reading requests from the durable log 1310, the processor 152 may use the offset manager 1360 to identify a next request to be read from the durable log 1310. For example, requests in the offset manager 1360, which have been read by the processor 152, may be ordered chronologically so that using a reference to a last request (request 2B in FIG. 13B), the processor 152 may increment a reference number (from 2 to 3) to identify a next request to be read from the durable log 1310.

In FIG. 13C, the processor 152 uses the pending request graph 1330 to determine that the pending request 1A is ready for processing and moves the pending request 1A to the ready queue 1340. Also in FIG. 13C, the processor 152 places the pending request 2B into the pending request graph 1330 (shown as an entry in the temporary queue 1320 having a dotted line border). In this example, the revisions for the request 1A and the request 2B do not have a dependency relationship, so the requests are placed as separate, unconnected nodes within the pending request graph 1330.

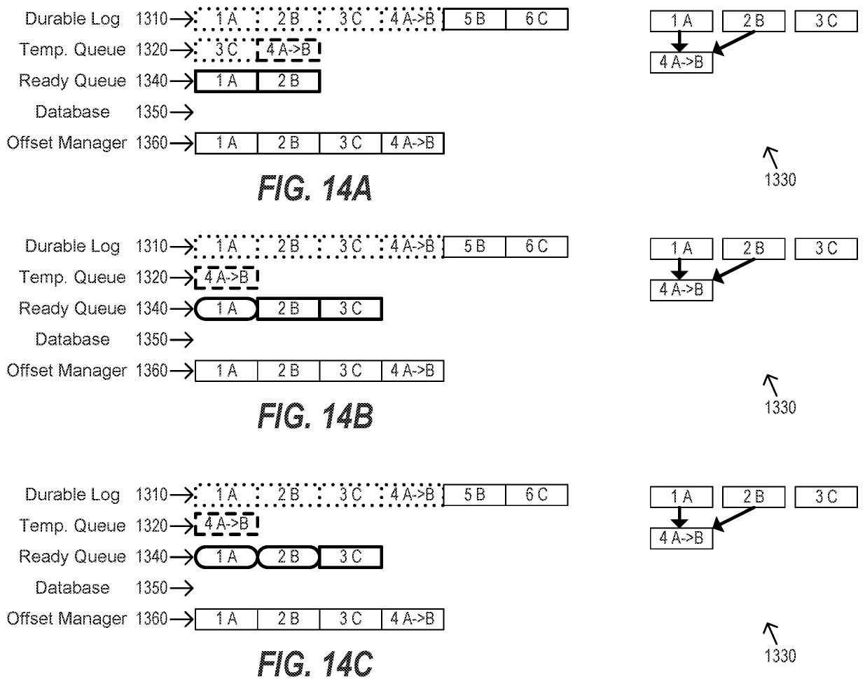

In FIG. 14A, the processor 152 reads pending requests 3C and 4A->B from the durable log 1310, places them in the temporary queue 1320, and adds corresponding nodes to the pending request graph 1330. The requests 3C and 4A->B are also tracked by the offset manager 1360. In the example shown in FIG. 14A, the pending request 3C does not have a dependency relationship with the pending requests 1A or 2B and the corresponding node is generated as a separate and unconnected node within the pending request graph 1330. However, the pending request 4A->B has a dependency relationship with both the requests 1A and 2B. Accordingly, the node 4A->B is created with edges indicating that the requests 1A and 2B are parent requests (i.e., the node 4A->B is a child node to nodes 1A and 2B).

At the time of FIG. 14A, the processor 152 uses the pending request graph 1330 to determine that the pending request 2B is ready for processing and moves the pending request 2B to the ready queue 1340. However, the processor 152 determines that the pending request 4A->B is blocked from being processed because the node 4A->B depends from the node 1A and the node 2B, neither of which has yet been completed at the time of FIG. 14A. The processor 152 may flag the pending request 4A->B as blocked or unavailable (shown with a bold dashed line border) until the requests associated with the nodes 1A and 2B have both been completed.

In FIG. 14B, the processor 152 uses the pending request graph 1330 to determine that the pending request 3C is ready for processing and moves the pending request 3C to the ready queue 1340. Processing of the pending request 1A is also started at the time of FIG. 14B, shown as an entry with a rounded solid line. For example, the processor 152 may assign or distribute the pending request 1A to a suitable processor (or group of processors) to be processed.

In FIG. 14C, processing of the pending request 2B is started (e.g., assigning 2B to a processor), such that processing of the pending requests 1A and 2B is performed in parallel.

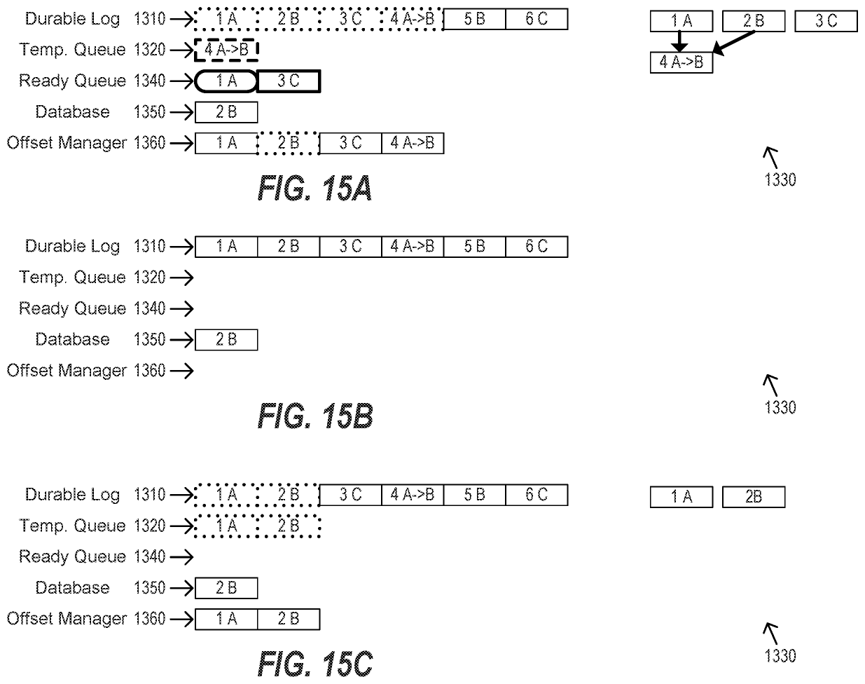

In FIG. 15A, processing of the pending request 2B has completed and the request 1A is still being processed. After processing, pending requests may be temporarily flagged as complete, in some scenarios. For example, before a request is flagged as committed in the durable log 1310, the request may be stored in the database 1350 until a sequential group of pending requests may be committed. At the time of FIG. 15A, the revision for the request 2B has been performed and completed, but committing the request 2B would potentially result in an unstable state of the workspace for the durable log 1310 because the request 1A is not yet ready to be committed. Accordingly, the request 2B is stored in the database 1350 and flagged as completed in the offset manager 1360, shown with a dotted line border. The processor 152 may wait until a sequential group is ready to be committed before committing the request 2B to the durable log 1310, as described above.

Turning to FIG. 15B, in the event of a system crash or other issue in service, requests and data structures that were stored in memory may be lost. FIG. 15B shows a system state after a crash where the temporary queue 1320, the pending request graph 1330, the ready queue 1340, and the offset manager 1360 have been cleared.

In FIG. 15C, the processor 152 recovers from a system crash by reading from the durable log 1310. Since the offset manager 1360 has been cleared and the next request to be read cannot be determined by incrementing a reference number, the processor 152 may use the commit reference or other suitable reference associated with the durable log 1310 to identify which request should be read from the durable log 1310. At the time of FIG. 15C, no requests have been committed, so the first uncommitted request is request 1A. The processor 152 reads pending requests 1A and 2B from the durable log 1310 and places them in the temporary queue 1320 and offset manager 1360, as described above. Although the request 2B has already been completed and stored in the database 1350, the processor 152 repeats appropriate actions for handling the request 2B, for example, to ensure durability and persistence. Although some actions may be duplicated in the event of a crash due to a loss of memory when the temporary queue 1320, the ready queue 1340, the pending request graph 1330, and the offset manager 1360 are stored in the memory, this duplication is generally an acceptable or even beneficial tradeoff for improved speed to these elements when stored in memory instead of a solid state disk or other media.

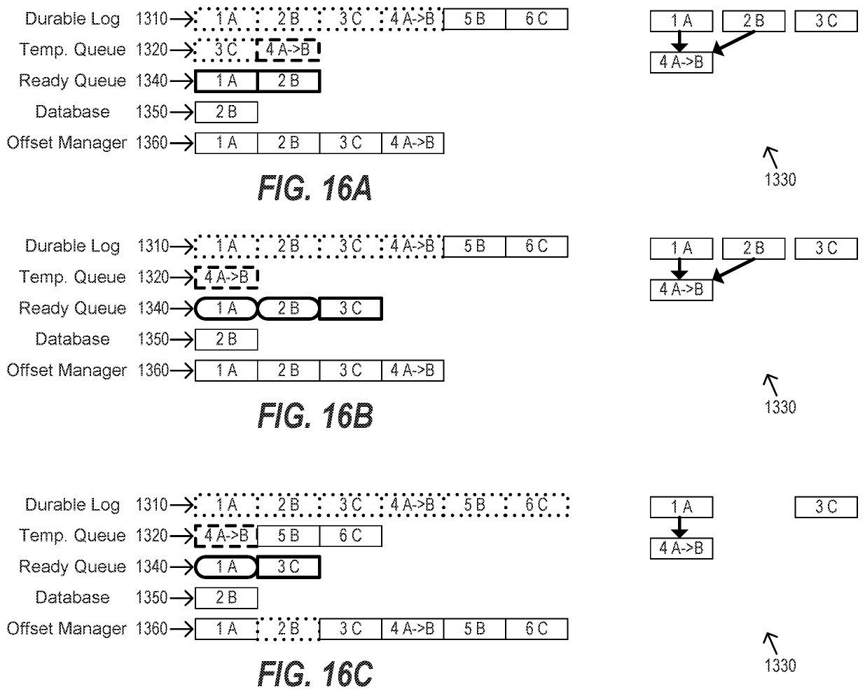

In FIG. 16A, the processor 152 reads pending requests 3C and 4A->B from the durable log 1310 and places them in the temporary queue 1320 and offset manager 1360. At the time of FIG. 16A, the processor 152 uses the pending request graph 1330 to determine that the pending requests 1A and 2B are ready for processing and moves them to the ready queue 1340. The processor 152 also adds nodes to the pending request graph 1330 for the pending requests 3C and 4A->B. Based on the pending request graph 1330, the processor 152 may flag the pending request 4A->B as blocked or unavailable (shown with a bold dashed line border) until the requests associated with the nodes 1A and 2B have both been completed.

In FIG. 16B, the processor 152 uses the pending request graph 1330 to determine that the pending request 3C is ready for processing and moves the pending request 3C to the ready queue 1340. Additionally, the processor 152 assigns or distributes the pending request 2B to a processor.

In FIG. 16C, the processor 152 reads pending requests 5B and 6C from the durable log 1310 and places them in the temporary queue 1320. At the time of FIG. 16C, the request 2B has been completed, marked as such in the offset manager 1360, and stored in the database 1350. In one example, the processor 152 stores the request 2B at FIG. 16C over, or updates, an earlier entry for the request 2B (FIG. 15A). In another example, the processor 152 checks for and removes earlier entries for a same request before re-entering the request as having been completed. The processor 152 also removes the request 2B from the pending request graph 1330.

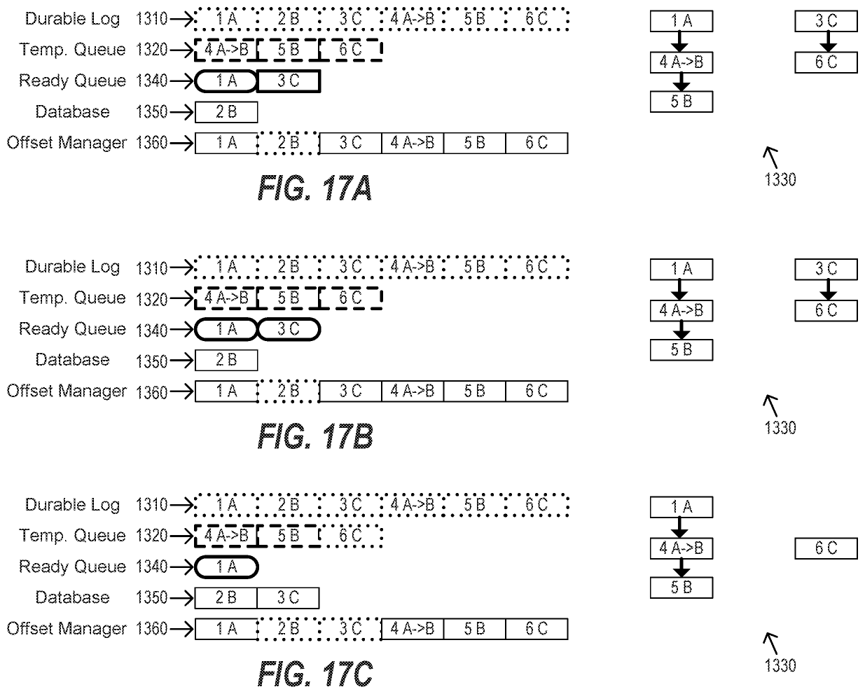

In FIG. 17A, pending requests 5B and 6A are placed into the pending request graph 1330. Additionally, the processor 152 uses the pending request graph 1330 to identify the requests 5B and 6C as blocked or not ready for processing. Specifically, request 5B depends from request 4A->B and request 6C depends from request 3C, which have not yet been processed.

In FIG. 17B, processing of the pending request 3C is started, shown as an entry with a rounded solid line.

In FIG. 17C, processing of the pending request 3C is completed and the request 3C is moved to the database 1350 and flagged as complete in the offset manager 1360. Upon completion of the request 3C, the processor 152 removes the request 3C from the pending request graph 1330 and also removes the block on the request 6C, based on the pending request graph 1330. In one example, the processor 152 reviews the pending request graph 1330 periodically (e.g., every second, every ten seconds, etc.) and prunes nodes for completed requests, for example, based on the requests listed in the database 1350 or flagged as completed in the offset manager 1360. In another example, the processor 152 removes a node when its corresponding request is completed, searches for child nodes of the removed node, and removes blocks from child nodes that no longer have uncompleted parent nodes.

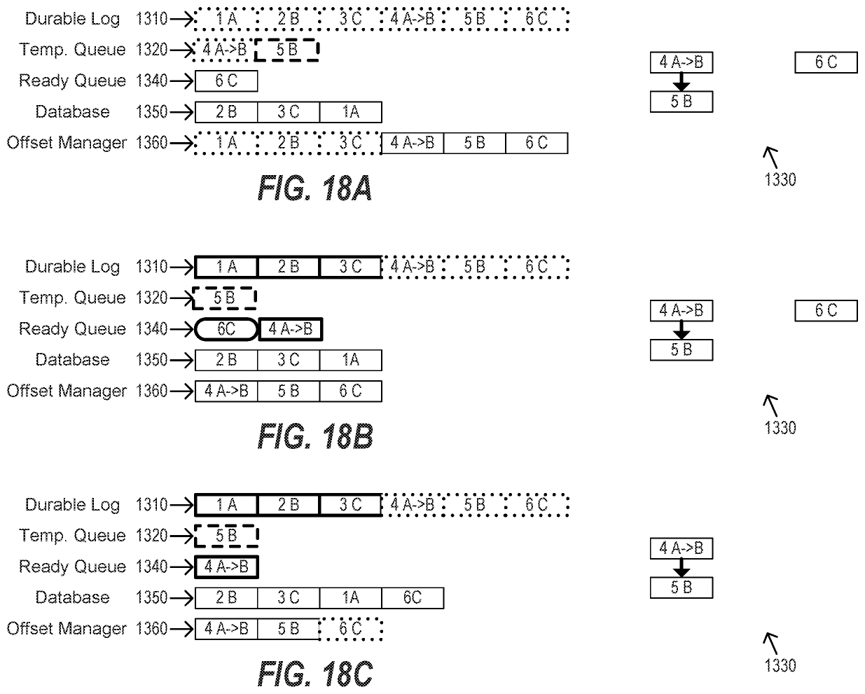

In FIG. 18A, the processor 152 uses the pending request graph 1330 to determine that the pending request 6C is ready for processing (after the block associated with request 3C is removed) and moves the pending request 6C to the ready queue 1340. At the time of FIG. 18A, processing of the pending request 1A is completed, the request 1A is moved to the database 1350, and the request 1A is flagged as complete in the offset manager 1360. Upon completion of the request 1A, the processor 152 removes the node for the request 1A from the pending request graph 1330 and also removes the block on the request 4A->B, based on the pending request graph 1330.

The processor 152 may also determine that the request 1A may be flagged as committed in the durable log 1310 (i.e., the node 1A does not have any parent nodes and the request has been completed). For example, after completion of the request 1A, the processor 152 determines that the corresponding node in the pending request graph 1330 does not have any associated parent nodes and that the commit reference corresponds to the request 1A.

In FIG. 18B, the processor 152 may assign the request 6C to a processor, move the request 4A->B to the ready queue 1340, flag the request 1A in the durable log 1310 as having been completed, and update the commit reference to correspond to request 2B. The processor 152 may similarly check the offset manager 1360 for a completion status of the request 2B and request 3C and flag the requests 2B and 3C in the durable log 1310 as having been completed. In other examples, multiple requests may be flagged as committed as part of a single operation, for example, flagging each of 1A, 2B, and 3C as committed in a single operation. For example, the processor 152 may determine that a sequential group of pending requests may be committed (the group of requests 1A, 2B, and 3C) by determining that a first entry of the offset manager 1360 has been completed and stepping through the offset manager 1360 until finding an entry for a request that has not yet been completed. The sequential group then includes the first entry up to, but not including the request that has not yet been completed. The sequential group can then be flagged as committed in the durable log 1310 and the commit reference can be updated to correspond to the incomplete request in the offset manager 1360. After flagging the requests as committed in the durable log 1310, the requests may be removed from the offset manager 1360.

In FIG. 18C, processing of the pending request 6C is completed, the pending request 6C is moved to the database 1350, and the pending request 6C is flagged as complete in the offset manager 1360. Although further steps for processing and committing requests in the durable log 1310 are not shown, similar steps as those described above may be performed.

The processor 152 has been described as reading sequential or chronological requests from the durable log 1310 for placement into the temporary queue 1320, but may read requests from the durable log 1310 according to various priorities, in other embodiments. In one example, the durable log 1310 comprises metadata about an estimated duration or processing load for a request to be completed (i.e., 10 seconds of processing, 21 billion floating point operations, 32 million read/write operations) and prioritizes the requests for processing so that they are completed in chronological order. In some scenarios using prioritization, the benefit of the offset manager 1360 may be reduced and the offset manager 1360 may be omitted. In some scenarios, prioritization reduces duplicate processing in the event of a system crash or other issue in service.

Although the durable log 1310, the temporary queue 1320, the ready queue 1340, the database 1350, and the offset manager 1360 have been described as separate queues or data structures, two or more of these elements may be combined in various embodiments. In one such example, the durable log 1310 is modified to have multiple flags to describe different stages of completion for the requests, such as a “read” flag, a “ready” flag, a “completed” flag, and a “committed flag.” As another example, the database 1350 and the offset manager 1360 may be combined so that the database 1350 includes a flag or linking data structure (e.g., a linked list among sequential requests) for tracking the status of the requests.

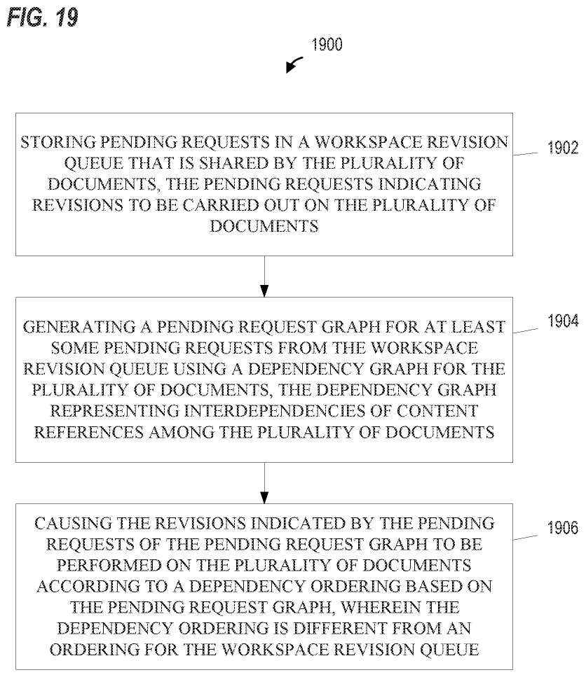

FIG. 19 is a flowchart illustrating an example method 1900, implemented on a server, for maintaining revisions for a plurality of documents, according to an embodiment. In some embodiments, the method 1900 is implemented by the productivity server 100 of FIG. 1, which interacts with the database server 106 and the client devices 104. FIG. 10 is described with reference to FIG. 1 for explanatory purposes. In other embodiments, however, the method 1900 is implemented by another suitable computing device.

At block 1902, pending requests are stored in a workspace revision queue that is shared by the plurality of documents. The pending requests indicate revisions to be carried out on the plurality of documents. As one example, the workspace revision queue may be the workspace revision queue 1200 with pending requests 1A, 2B, 3C, 4A->B, 5B, and 6C. In some examples, the workspace revision queue is a durable log of requests that are flagged as the pending requests or as processed requests indicating revisions that have been carried out on the plurality of documents. For example, the workspace revision queue may be the durable log 1310. In various examples, requests within the durable log 1310 may be flagged individually as either pending requests or processed requests, or the durable log 1310 may have a commit reference that references a next request to be committed or, in other words, a starting location of uncommitted requests within the durable log 1310.

At block 1904, a pending request graph is generated for at least some pending requests from the workspace revision queue using a dependency graph for the plurality of documents. The pending request graph may correspond to the pending request graph 1330 for the workspace revision queue 1200, for example. The dependency graph represents interdependencies of content references among the plurality of documents. As one example, the dependency graph may be similar to the dependency graphs 1150 and/or 1170.

Generating the pending request graph may comprise adding nodes to the pending request graph corresponding to the at least some pending requests where edges between nodes of the pending request graph indicate i) parent nodes for parent requests and ii) child nodes for child requests that depend from parent requests according to the dependency graph. For example, edges between the node 1A and the node 4A->B in FIG. 14A indicate that the request 1A is a parent request to the request 4A->B as a child request. As another example, edges between the nodes 3C and 6C in FIG. 17A indicate that the request 3C is a parent request to the request 6C as a child request. In some examples, nodes are added to the pending request graph based on a pessimistic relational impact for nodes among the pending request graph, as described above.

At block 1906, the revisions indicated by the pending requests of the pending request graph are caused to be performed on the plurality of documents according to a dependency ordering based on the pending request graph. For example, a revision for a pending request may be assigned or distributed to a processor, as described above. The dependency ordering is different from an ordering for the workspace revision queue. For example, the workspace revision queue may use a first in, first out (FIFO) order, while the dependency ordering is different from the FIFO order.

Causing the revisions at block 1906 may comprise identifying ready requests from nodes of the pending request graph that do not have incomplete parent nodes. In some examples, ready requests are identified and moved into the ready queue 1340. For example, the nodes 1A and 2B shown in FIG. 15C do not have incomplete parent nodes and are moved from the temporary queue 1320 (FIG. 15C) to the ready queue 1340 (FIG. 16A). As another example, the node 4A->B has two parent nodes (1A and 2B) in FIG. 16A that are incomplete (e.g., still present within the pending request graph 1330), so the node 4A->B would not yet be identified as a ready request. Nodes of the pending request graph are flagged as incomplete before and during processing of corresponding requests and flagged as complete after processing of the corresponding requests. For example, nodes may be flagged as incomplete when added to the pending request graph 1330 and flagged as complete when they are added to the database 1350. Causing the revisions at block 1906 may further comprise processing corresponding revisions for the ready requests (e.g., the pending requests in the ready queue 1340). In some scenarios, two or more revisions for the ready requests are processed in parallel, for example, by distributing the revisions to different instances of the processor 152.

In some examples, a pending request is flagged as a processed request in the durable log only when a corresponding revision has been processed and an earlier adjacent request in the durable log is a processed request. Moreover, flagging the pending request may comprise flagging a sequential group of pending requests as processed requests when each revision corresponding to pending requests of the sequential group has been processed and requests prior to the sequential group have been processed, as described above.

In some examples, identifying the ready requests comprises ordering and processing the ready requests according to positions of the ready requests in the workspace revision queue. In other words, processing of the ready requests may be performed in parallel, but when two requests are available, an earlier request may receive priority.

In some examples, the dependency graph is generated for the plurality of documents before storing the pending requests in the workspace revision queue. For example, as documents are created and/or modified within a workspace, the dependency graph is created and/or updated such that the dependency graph is accessible shortly after, or preferably before, the time of reading the pending entries from the durable log 1310. The dependency graph may be updated according to the processed ready requests. For example, after a modification of the document C to have a dependency relationship to document B (e.g., due to a formula that links content data from document B), the dependency graphs may be updated so that future requests for revisions to document C depend from requests for revisions to document B.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the disclosure, reference has been made to the embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art. The terminology used herein is for the purpose of describing the particular embodiments and is not intended to be limiting of exemplary embodiments of the disclosure. In the description of the embodiments, certain detailed explanations of related art are omitted when it is deemed that they may unnecessarily obscure the essence of the disclosure.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, solid state drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the disclosure pertains may easily implement functional programs, codes, and code segments for making and using the disclosure.

The disclosure may be described in terms of functional block components and various processing steps. Such functional blocks may be realized by any number of hardware and/or software components configured to perform the specified functions. For example, the disclosure may employ various integrated circuit components, e.g., memory elements, processing elements, logic elements, look-up tables, and the like, which may carry out a variety of functions under the control of one or more microprocessors or other control devices. Similarly, where the elements of the disclosure are implemented using software programming or software elements, the disclosure may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the disclosure may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure as defined by the following claims. Therefore, the scope of the disclosure is defined not by the detailed description of the disclosure but by the following claims, and all differences within the scope will be construed as being included in the disclosure.

No item or component is essential to the practice of the disclosure unless the element is specifically described as “essential” or “critical”. It will also be recognized that the terms “comprises”, “comprising”, “includes”, “including”, “has”, and “having”, as used herein, are specifically intended to be read as open-ended terms of art. The use of the terms “a” and “an” and “the” and similar referents in the context of describing the disclosure (especially in the context of the following claims) are to be construed to cover both the singular and the plural, unless the context clearly indicates otherwise. In addition, it should be understood that although the terms “first”, “second”, etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method for maintaining revisions for a plurality of documents, the method carried out by one or more computing devices and comprising:
storing pending requests in a workspace revision queue that is shared by the plurality of documents, the pending requests indicating revisions to be carried out on the plurality of documents;
generating a pending request graph for at least some pending requests from the workspace revision queue using a dependency graph for the plurality of documents, the dependency graph representing interdependencies of content references among the plurality of documents; and
causing the revisions indicated by the pending requests of the pending request graph to be performed on the plurality of documents according to a dependency ordering based on the pending request graph, wherein the dependency ordering is different from an ordering for the workspace revision queue.

2. The method of claim 1, wherein storing the pending requests comprises storing the pending requests using a first in, first out (FIFO) ordering for the workspace revision queue.

3. The method of claim 1, wherein:
generating the pending request graph comprises adding nodes to the pending request graph corresponding to the at least some pending requests; and
edges between nodes of the pending request graph indicate parent nodes for parent requests and child nodes for child requests that depend from parent requests according to the dependency graph.

4. The method of claim 3, wherein causing the revisions comprises:
identifying ready requests from nodes of the pending request graph that do not have incomplete parent nodes, wherein nodes of the pending request graph are flagged as incomplete before and during processing of corresponding requests and flagged as complete after processing of the corresponding requests; and
processing corresponding revisions for the ready requests.

5. The method of claim 4, wherein processing the revisions for the ready requests comprises processing two or more revisions for the ready requests in parallel.

6. The method of claim 4, wherein identifying the ready requests comprises ordering and processing the ready requests according to positions of the ready requests in the workspace revision queue.

7. The method of claim 6, the method further comprising generating the dependency graph for the plurality of documents before storing the pending requests in the workspace revision queue.

8. The method of claim 7, the method further comprising updating the dependency graph according to the processed ready requests.

9. The method of claim 3, wherein adding the nodes to the pending request graph comprises adding the nodes based on a pessimistic relational impact for nodes among the pending request graph.

10. The method of claim 1, wherein the workspace revision queue is a durable log of requests that are flagged as the pending requests or as processed requests indicating revisions that have been carried out on the plurality of documents.

11. The method of claim 10, the method further comprising flagging a pending request as a processed request in the durable log only when a corresponding revision has been processed and an earlier adjacent request in the durable log is a processed request.

12. The method of claim 11, wherein flagging the pending request comprises flagging a sequential group of pending requests as processed requests when each revision corresponding to pending requests of the sequential group has been processed and requests prior to the sequential group have been processed.

13. A computing device that maintains revisions for a plurality of documents, the computing device comprising a processor and a non-transitory computer-readable memory, wherein the processor is configured to carry out instructions from the memory that configure the computing device to:
store pending requests in a workspace revision queue that is shared by the plurality of documents, the pending requests indicating revisions to be carried out on the plurality of documents;
generate a pending request graph for at least some pending requests from the workspace revision queue using a dependency graph for the plurality of documents, the dependency graph representing interdependencies of content references among the plurality of documents; and
cause the revisions indicated by the pending requests of the pending request graph to be performed on the plurality of documents according to a dependency ordering based on the pending request graph, wherein the dependency ordering is different from an ordering for the workspace revision queue.

14. The computing device of claim 13, wherein the processor is configured to carry out instructions from the memory that configure the computing device to:
add nodes to the pending request graph corresponding to the at least some pending requests; and
wherein edges between nodes of the pending request graph indicate parent nodes for parent requests and child nodes for child requests that depend from parent requests according to the dependency graph.

15. The computing device of claim 14, wherein the processor is configured to carry out instructions from the memory that configure the computing device to:
identify ready requests from nodes of the pending request graph that do not have incomplete parent nodes, wherein nodes of the pending request graph are flagged as incomplete before and during processing of corresponding requests and flagged as complete after processing of the corresponding requests; and
process corresponding revisions for the ready requests, including processing two or more revisions for the ready requests in parallel.

16. The computing device of claim 15, wherein the processor is configured to carry out instructions from the memory that configure the computing device to:
order and process the ready requests according to positions of the ready requests in the workspace revision queue; and
store the pending requests using a first in, first out (FIFO) ordering for the workspace revision queue.

17. The computing device of claim 16, wherein the processor is configured to carry out instructions from the memory that configure the computing device to:
generate the dependency graph for the plurality of documents before storing the pending requests in the workspace revision queue; and
update the dependency graph according to the processed ready requests.

18. The computing device of claim 14, wherein the processor is configured to carry out instructions from the memory that configure the computing device to:
add the nodes based on a pessimistic relational impact for nodes among the pending request graph.

19. The computing device of claim 13, wherein the workspace revision queue is a durable log of requests that are flagged as the pending requests or as processed requests indicating revisions that have been carried out on the plurality of documents;
wherein the processor is configured to carry out instructions from the memory that configure the computing device to:
flag a pending request as a processed request in the durable log only when a corresponding revision has been processed and an earlier adjacent request in the durable log is a processed request.

20. The computing device of claim 19, wherein the processor is configured to carry out instructions from the memory that configure the computing device to:
flag a sequential group of pending requests as processed requests when each revision corresponding to pending requests of the sequential group has been processed and requests prior to the sequential group have been processed.
